(19) United States
(12) Patent Application Publication
(10) Pub. No.: US 2023/0305513 A1
(43) Pub. Date: Sep. 28, 2023

(54) CUTTING APPARATUS AND METHOD FOR SPECIFYING POSITIONAL RELATIONSHIP

(71) Applicant: National University Corporation Tokai National Higher Education and Research System, Aichi-ken (JP)

(72) Inventor: Eiji SHAMOTO, Aichi-ken (JP)

(21) Appl. No.: 18/156,136

(22) Filed: Jan. 18, 2023

Related U.S. Application Data
(63) Continuation of application No. PCT/JP2022/014005, filed on Mar. 24, 2022.

(51) Int. Cl. G05B 19/402

(52) U.S. Cl. CPC G05B 19/402; G05B 2219/37436; G05B 2219/45044

(57) ABSTRACT

A motion controller moves a cutting tool relative to a workpiece in a direction in which the cutting tool and the workpiece come into contact with each other while imparting rotary motion or motion along a predetermined locus to one of the cutting tool or the workpiece. An acquirer acquires a signal indicating whether the cutting tool and the workpiece are in contact with each other. A processor specifies a section during which the cutting tool and the workpiece are in contact with each other from the signal acquired by the acquirer and specifies a relative positional relationship between the cutting tool and the workpiece from the section thus specified.

### CROSS REFERENCE TO RELATED APPLICATIONS

This application is based upon and claims the benefit of priority from International Application No. PCT/JP2022/014005, filed on Mar. 24, 2022, the entire contents of which are incorporated herein by reference.

### BACKGROUND

### 1. Field of the Disclosure

The present disclosure relates to a cutting apparatus that cuts a workpiece using a cutting tool, and a method for specifying a relative positional relationship between the workpiece and the cutting tool.

### 2. Description of the Related Art

In machining, a workpiece (also referred to as a work object or a work) is fixed to a table or a spindle of a cutting apparatus, a tool is fixed to a tool post (turret) or the spindle, and shape creation is performed by relative movement between the tool and the workpiece. In order to achieve highly accurate shape creation, it is necessary to perform preparation work (setup) for specifying a relative positional relationship between the tool and the workpiece before machining.

JP 2018-508374 A discloses a method by which a voltage is applied between a tool and a work object, the tool is moved relative to the work object, a change in the voltage when the tool and the workpiece come into contact with each other is determined, and a position of the work object and/or the tool at the time of contact is determined.

WO 2020/174585 A discloses a technique for specifying a contact position between a cutting tool and a workpiece from a first time-series data of a detection value related to a drive motor acquired before contact and a second time-series data of a detection value related to the drive motor acquired after the contact. The contact between the cutting tool and the workpiece is specified by using a regression equation obtained by regression analysis of the second time-series data.

The method for detecting the contact between the tool and the workpiece using the presence or absence of electric continuity has an advantage that the method can be implemented with high sensitivity and at low cost. However, in a machine tool such as a planing machine that performs free-form surface machining using a non-rotary tool, when the cutting edge is brought into contact with the workpiece by linearly moving the cutting edge, the tool may be damaged. Although it is also possible to decelerate and stop the tool and retract the tool at the moment when continuity is detected, a deceleration period until the tool stops cannot be made zero, so that there is still a possibility that the tool is damaged.

Further, in a case of a rotary tool, an attachment angle position of the tool cutting edge is generally unknown, and when the rotary tool being rotating is brought into contact with the workpiece, cutting is made by a depth of cut less than or equal to a feed amount per rotation (or per cutting edge) at the moment of contact, so that a cutting start position cannot be accurately specified. In a case of turning using a non-rotary tool, the workpiece is generally attached with minute eccentricity, but the rotational position of the eccentricity is generally unknown, and when the workpiece being rotating is brought into contact with the non-rotary tool, cutting is made by a depth of cut less than or equal to the feed amount per rotation at the moment of contact, so that a cutting start position cannot be accurately specified. Specifically, under the method using electric continuity, it is possible to detect that the tool and the workpiece come into contact with each other, but when the tool and the workpiece come into contact with each other, the tool is at a position advanced from the cutting start position relative to the workpiece, and the tool position at the moment of contact is different from the cutting start position.

### SUMMARY

The present disclosure has been made in view of such circumstances, and it is therefore an object of the present disclosure to provide a technique for specifying, with accuracy, a relative positional relationship between a tool and a workpiece.

In order to solve the above-described problems, a cutting apparatus according to an aspect of the present disclosure includes a motion controller structured to move a cutting tool relative to a workpiece in a direction in which the cutting tool and the workpiece come into contact with each other while imparting rotary motion or motion along a predetermined locus to one of the cutting tool or the workpiece, an acquirer structured to acquire a signal indicating whether the cutting tool and the workpiece are in contact with each other, and a processor structured to specify a section during which the cutting tool and the workpiece are in contact with each other from the signal acquired by the acquirer and specify a relative positional relationship between the cutting tool and the workpiece from the section thus specified.

A method for specifying a positional relationship according to another aspect of the present disclosure is a method for specifying a relative positional relationship between a cutting tool and a workpiece, the method including imparting rotary motion or motion along a predetermined locus to one of the cutting tool or the workpiece, moving the cutting tool relative to the workpiece in a direction in which the cutting tool and the workpiece come into contact with each other, acquiring a signal indicating whether the cutting tool and the workpiece are in contact with each other, specifying a section during which the cutting tool and the workpiece are in contact with each other from the signal thus acquired, and specifying a relative positional relationship between the cutting tool and the workpiece from the section thus specified. The imparting rotary motion or motion along a predetermined locus to one of the cutting tool or the workpiece and the moving the cutting tool relative to the workpiece in a direction in which the cutting tool and the workpiece come into contact with each other may be performed separately or simultaneously.

A cutting apparatus according to another aspect of the present disclosure includes a motion controller structured to move a cutting tool relative to a workpiece in a direction in which the cutting tool and the workpiece come into contact with each other while imparting motion along a predetermined locus to one of the cutting tool or the workpiece, an acquirer structured to acquire a signal indicating whether the cutting tool and the workpiece are in contact with each other, and a processor structured to specify a timing at which the cutting tool and the workpiece come into contact with each other or a timing at which the cutting tool and the workpiece come out of contact with each other from the signal acquired by the acquirer and specify a relative positional relationship between the cutting tool and the workpiece at the timing thus specified.

A method for specifying a positional relationship according to another aspect of the present disclosure is a method for specifying a relative positional relationship between a cutting tool and a workpiece, the method including imparting motion along a predetermined locus to one of the cutting tool or the workpiece, moving the cutting tool relative to the workpiece in a direction in which the cutting tool and the workpiece come into contact with each other, acquiring a signal indicating whether the cutting tool and the workpiece are in contact with each other, specifying a timing at which the cutting tool and the workpiece come into contact with each other or a timing at which the cutting tool and the workpiece come out of contact with each other from the signal thus acquired, and specifying a relative positional relationship between the cutting tool and the workpiece at the timing thus specified. The imparting motion along a predetermined locus to one of the cutting tool or the workpiece and the moving the cutting tool relative to the workpiece in a direction in which the cutting tool and the workpiece come into contact with each other may be performed separately or simultaneously.

Note that any combination of the above-described components, or an entity that results from replacing expressions of the present disclosure among a method, an apparatus, a system, and the like is also valid as an embodiment of the present disclosure.

### BRIEF DESCRIPTION OF THE DRAWINGS

FIG. 1 is a diagram showing a schematic structure of a cutting apparatus according to a first embodiment;

FIG. 2 is a diagram showing an example of an electric signal measured by a measurer;

FIG. 3 is a diagram schematically showing a state where a tool cutting edge comes into contact with a workpiece;

FIG. 4 is a diagram showing a duty cycle calculated for each time section;

FIG. 5 is a diagram showing an example of a regression curve;

FIG. 6 is a diagram showing a duty cycle calculated from a relational expression;

FIG. 7 is a diagram showing an example of an electric signal measured by the measurer;

FIG. 8 is a diagram showing a duty cycle calculated for each time section;

FIG. 9 is a diagram showing an example of a regression curve;

FIG. 10 is a diagram schematically showing a state where the tool cutting edge comes into contact with the workpiece;

FIG. 11 is a diagram showing a schematic structure of a cutting apparatus according to a second embodiment;

FIG. 12 is a diagram showing an example of an electric signal measured by a measurer;

FIG. 13 is a diagram schematically showing a state where a tool cutting edge comes into contact with a workpiece;

FIG. 14 is a diagram showing a duty cycle calculated for each time section;

FIG. 15 is a diagram showing an example of a regression curve;

FIG. 16 is a diagram showing a duty cycle calculated from a relational expression;

FIG. 17 is a diagram showing a schematic structure of a cutting apparatus according to a third embodiment;

FIG. 18 is a diagram schematically showing a state where a tool cutting edge comes into contact with a workpiece;

FIG. 19 is a diagram showing a relationship between a locus motion of the cutting edge and an electric signal being measured;

FIGS. 20A, 20B, and 20C are diagrams showing examples of a motion locus;

FIG. 21 is a diagram showing a relationship between the locus motion of the cutting edge and the electric signal being measured; and

FIG. 22 is a diagram showing a schematic structure of a cutting apparatus according to a fourth embodiment.

### DETAILED DESCRIPTION

The disclosure will now be described by reference to the preferred embodiments. This does not intend to limit the scope of the present disclosure, but to exemplify the disclosure.

### First Embodiment

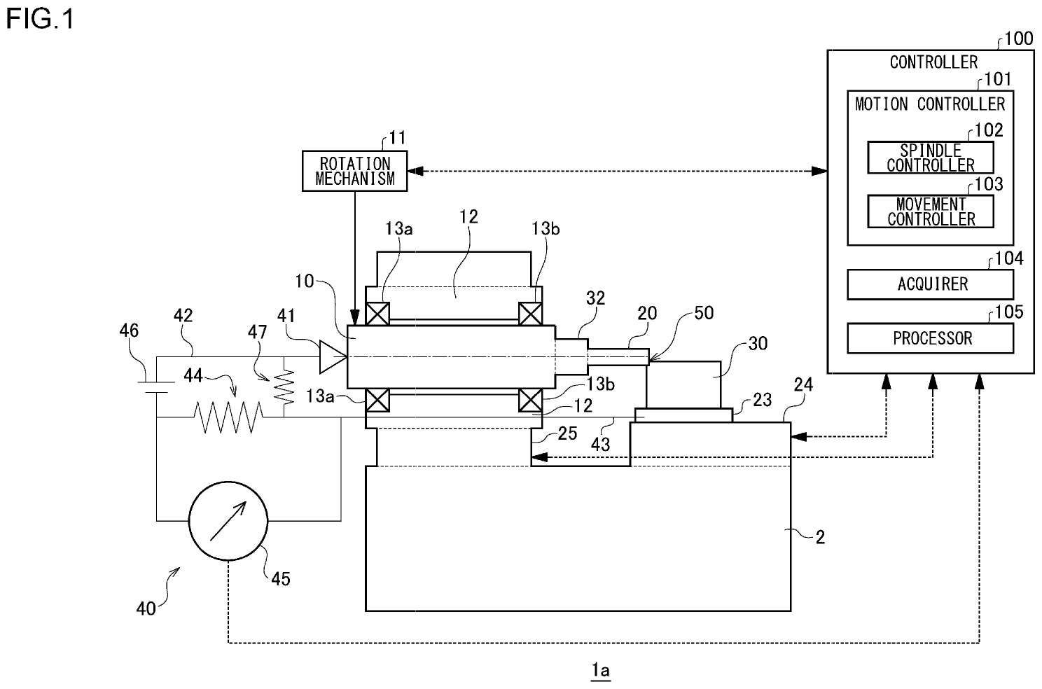

FIG. 1 shows a schematic structure of a cutting apparatus 1a according to a first embodiment. The cutting apparatus 1a has a function of bringing, in order to specify a relative positional relationship between a cutting tool 20 and a workpiece 30, the cutting tool 20 and the workpiece 30 into contact with each other before starting a full-scale cutting process to derive the relative positional relationship.

The cutting apparatus 1a according to the first embodiment is a horizontal milling machine or a horizontal machining center that rotates the cutting tool 20 attached to a spindle 10 with a holder 32 interposed between the cutting tool 20 and the spindle 10 to cause a cutting edge of cutting tool 20 being rotating to cut into the workpiece 30. In the first embodiment, the spindle 10, the holder 32, the cutting tool 20, the workpiece 30, and a workpiece fixing part 23 are conductors, and the cutting edge of the cutting tool 20 cuts the workpiece 30 at a cutting point 50. For the cutting process, a cutting tool 20 made of a conductive tool material (cemented carbide, high-speed tool steel, PCD, CBN, etc.) tend to be used. Although such tools are often coated, most of the coating films are conductive. For a precision process, a non-conductive diamond tool is used. In this case, the cutting tool 20 is preferably a conductive diamond tool, and may be any one of a monocrystalline diamond tool, a diamond-coated tool, or a polycrystalline diamond tool.

The cutting apparatus 1a includes, on a bed 2, feed mechanisms 24, 25 that move the cutting tool 20 relative to the workpiece 30. The workpiece 30 is fixed to the workpiece fixing part 23, and the workpiece fixing part 23 is supported by the feed mechanism 24 in a movable manner. A spindle housing 12 is supported by the feed mechanism 25 in a movable manner. In the cutting apparatus 1a, the feed mechanism 24 moves the workpiece fixing part 23 in an X-axis direction (front-rear direction), and the feed mechanism 25 moves the spindle housing 12 in a Y-axis direction (up-down direction) and a Z-axis direction (left-right direction), so as to move the cutting tool 20 relative to the workpiece 30. Note that the left-right direction means an axial direction of the spindle 10, the up-down direction means a vertical direction, and the front-rear direction means a direction orthogonal to the axial direction of the spindle 10 and the vertical direction. The feed mechanisms 24, 25 may each include a motor and a ball screw for each axis.

The spindle 10 is supported by the spindle housing 12 in a rotatable manner, and specifically, bearings 13a, 13b made of metal and fixed to the spindle housing 12 support the spindle 10 in a rotatable manner. A rotation mechanism 11 includes a mechanism that rotates the spindle 10, and includes a motor and a transmission structure that transmits rotational power of the motor to the spindle 10. The transmission structure may include a V-belt or a gear that transmits the rotational power of the motor to the spindle 10. Note that the rotation mechanism 11 is a built-in motor built into the spindle 10, and may directly drive the spindle 10.

The cutting apparatus 1a includes a voltage application unit 46 that applies a predetermined voltage between the cutting tool 20 and the workpiece 30. A contact monitor 40 monitors whether the cutting tool 20 and the workpiece 30 are in contact with each other. The contact monitor 40 includes a contact structure 41 electrically connected to the spindle 10 being rotating, a conducting wire 42 electrically connected to the contact structure 41, a conducting wire 43 electrically connected to the workpiece 30, an electric resistance 47 provided between the conducting wire 42 and the conducting wire 43, an electric resistance 44 provided between the conducting wire 42 and the conducting wire 43, and a measurer 45 that measures a voltage applied to the electric resistance 44. The contact monitor 40 may monitor a change in voltage across the electric resistance 44 caused by the contact between the cutting tool 20 and the workpiece 30 to detect whether the cutting tool 20 and the workpiece 30 come into contact with each other. Note that the measurer 45 may have a function of measuring a current flowing through the electric resistance 44. In the cutting apparatus 1a, the conducting wire 43 is connected to the workpiece fixing part 23 that fixes the workpiece 30, and the contact structure 41 is in contact with a rotation center of the spindle 10. A peripheral speed of the rotation center is theoretically zero, so that the contact structure 41 is in contact with the rotation center of the spindle 10 to avoid wearing the contact point.

In the contact monitor 40, the electric resistance 47 is provided to prevent electric noise from being generated when the cutting tool 20 and the workpiece 30 are out of contact with each other. In a case where the electric resistance 47 serving as an anti-noise resistance is not provided, the electric circuit is opened when the cutting tool 20 and the workpiece 30 are out of contact with each other, and the contact monitor 40 detects continuity (conduction) of the electric circuit when the cutting tool 20 and the workpiece 30 come into contact with each other, thereby detecting contact between the cutting tool 20 and the workpiece 30. Hereinafter, for the sake of convenience, the contact monitor 40 employs an electric circuit that does not include the electric resistance 47 serving as an anti-noise resistance in order to simplify a waveform of the voltage measured across the electric resistance 44. Therefore, the contact monitor 40 monitors whether the cutting tool 20 and the workpiece 30 come into contact with each other on the basis of the presence or absence of electrical continuity in the electric circuit.

A controller 100 includes a motion controller 101 that controls motion of the cutting tool 20 and/or the workpiece 30, an acquirer 104 that acquires an electric signal measured by the measurer 45, and a processor 105 that specifies a relative positional relationship between the cutting tool 20 and the workpiece 30 from the electric signal acquired by the acquirer 104. The motion controller 101 has a function of moving the cutting tool 20 relative to the workpiece 30 in a direction in which the cutting tool 20 and the workpiece 30 come into contact with each other while imparting rotary motion to one of the cutting tool 20 or the workpiece 30. The motion controller 101 includes a spindle controller 102 that controls the rotary motion of the spindle 10 imparted by the rotation mechanism 11, and a movement controller 103 that controls relative movement (feed motion) between the cutting tool 20 and the workpiece 30 imparted by the feed mechanisms 24, 25.

Each element described as a functional block of the controller 100 may be implemented, in terms of hardware, by a circuit block, a memory, other LSI, a CPU, and the like, and be implemented, in terms of software, by system software, an application program loaded into the memory, and the like. Therefore, it is to be understood by those skilled in the art that these functional blocks may be implemented in various forms such as hardware only, software only, or a combination of hardware and software, and how to implement the functional blocks is not limited to any one of the above.

In the contact monitor 40, the electric signal for the cutting tool 20 is extracted from the contact structure 41 in contact with a rear end of the spindle 10. It is therefore preferable that the spindle 10 and the spindle housing 12 be electrically insulated from each other, but the bearings 13a 13b are made of metal, and the spindle 10 in a stopped state (non-rotating state) is short-circuited to the spindle housing 12.

Regarding this point, the present discloser has obtained, as a finding, that when the spindle 10 rotates at a rotation speed equal to or higher than a predetermined rotation speed RS, a fluid lubrication condition is created in the bearings 13a, 13b to cause a phenomenon in which the spindle 10 and the spindle housing 12 are electrically disconnected from each other due to lubricating oil. In the cutting apparatus 1a using this phenomenon, when the spindle controller 102 rotates the spindle 10 at a predetermined rotation speed equal to or higher than the rotation speed RS, the movement controller 103 controls the feed mechanisms 24, 25 to cause the cutting tool 20 to cut into the workpiece 30, and the acquirer 104 acquire a voltage signal measured by the measurer 45 together with time information (time stamp) and stores the voltage signal and the time information into a memory (not shown). Note that the rotation speed RS is determined in a manner that depends on the bearings and is a rotation speed of several hundred revolutions per minute. Therefore, in the cutting apparatus 1a, the measurer 45 can measure the voltage across the electric resistance 44 without adding an insulating component between the spindle 10 and the spindle housing 12.

When the measurer 45 measures the voltage, the spindle 10 and the rotation mechanism 11 also need to be electrically insulated from each other. For example, when the rotation mechanism 11 uses a V-belt as a power transmission structure, the V-belt may be made of an insulating material such as rubber to electrically insulate the spindle 10 from the rotation mechanism 11. When the rotation mechanism 11 uses gears as the power transmission structure, the fluid lubrication condition is created between the gears being rotating as described above, lubricating oil is interposed between meshing teeth, and the spindle 10 is electrically insulated from the rotation mechanism 11 accordingly. Therefore, in the cutting apparatus 1a, the measurer 45 can measure the voltage across the electric resistance 44 without adding an insulating component between the spindle 10 and the rotation mechanism 11.

A description will be given below of a method for deriving a relative positional relationship between the cutting tool 20 and the workpiece 30 in the cutting apparatus 1a according to the first embodiment. Under this method, with the cutting tool 20 rotating, the cutting tool 20 is moved relative to the workpiece 30 in the Y-axis direction (up-down direction), and the electric signal measured by the measurer 45 after the tool cutting edge starts to cut into (or come into contact with) the workpiece 30 is analyzed to derive the relative positional relationship.

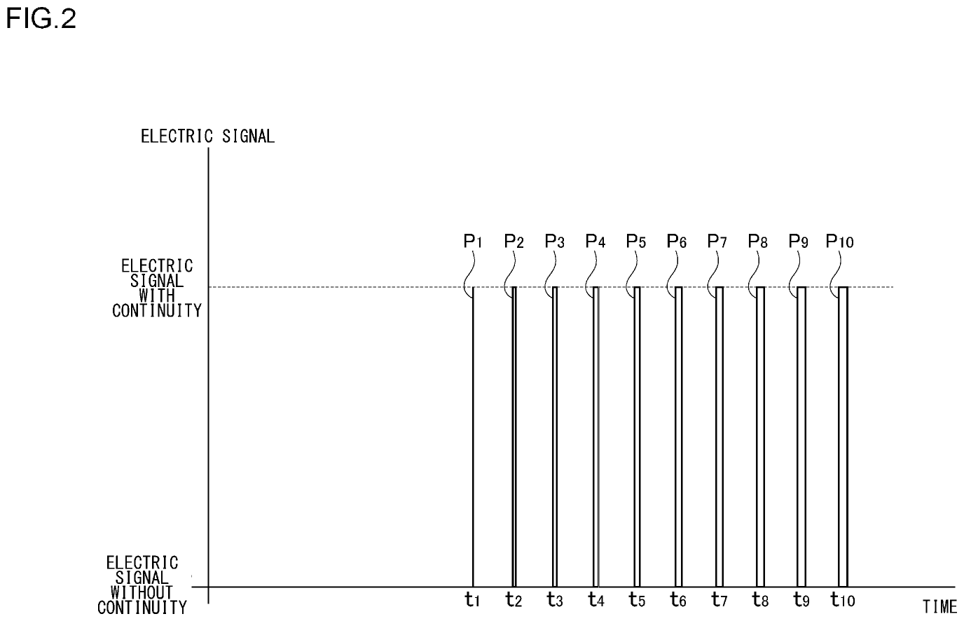

FIG. 2 shows an example of an electric signal measured by the measurer 45. During the measurement by the measurer 45, the rotation speed of the spindle 10 is constant, and the feed rate of the workpiece 30 relative to the cutting tool 20 is also constant. The measurer 45 measures an electric signal indicating whether the cutting tool 20 and the workpiece 30 are in contact with each other. In a graph shown in FIG. 2, the vertical axis represents the electric signal (here, voltage signal) measured by the measurer 45, and the horizontal axis represents time when the cutting tool 20 and the workpiece 30 are relatively moved (brought close to each other) at the constant feed rate. Note that when the feed rate is variable, the horizontal axis may represent a coordinate value of the feed mechanism 24. In the example shown in FIG. 2, the cutting tool 20 being used is a single-point (single-blade) milling tool.

When the single-point milling tool starts to cut into the workpiece 30, as shown in FIG. 2, the contact monitor 40 detects continuity only when the tool cutting edge is in contact with the workpiece 30, and specifically, the measurer 45 measures pulsed voltages P₁ to P₁₀. The continuity period (pulse width) corresponds to an angle by which the tool cutting edge comes into contact with the workpiece 30, and the larger the contact angle viewed from the rotation center, the longer the continuity period. Note that, when the electric resistance 47 serving as an anti-noise resistance is provided in the electric circuit, the measurer 45 measures a voltage different from a voltage when the tool cutting edge is in contact with the workpiece 30 and a voltage when the tool cutting edge is out of contact with the workpiece 30.

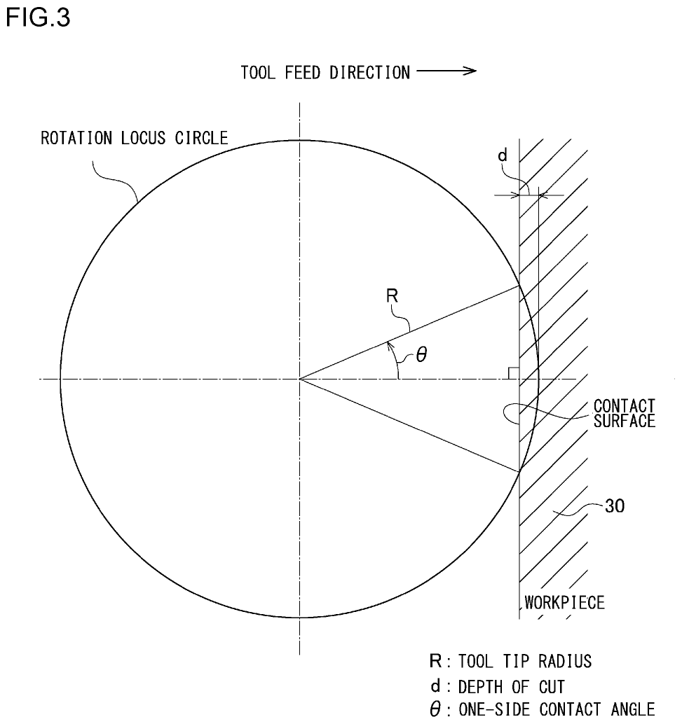

FIG. 3 schematically shows a state where the tool cutting edge comes into contact with the workpiece. When a contact surface of the workpiece 30 with which the tool tip (cutting edge) comes into contact can be regarded as a flat surface, and a tool feed amount per rotation is minute relative to a tool tip radius R, a period of the midpoint of the continuity period almost coincides with a rotation period T of the spindle 10. In FIG. 3, the tool tip radius R indicates a radius of an outermost peripheral point of the cutting tool 20 (a tool tip position located at an outermost periphery during rotation), and thus a rotation locus circle represents a rotation locus of the tool outermost peripheral point. In FIG. 2 showing 10 voltage pulses P₁ to P₁₀ measured in time series, as the depth of cut increases with time, a contact angle section (2θ) increases, and the pulse width of the voltage pulse increases with time.

Returning to FIG. 1, the measurer 45 measures the electric signal (voltage signal) indicating whether the cutting tool 20 and the workpiece 30 are in contact with each other and supplies the electric signal to the controller 100, and the acquirer 104 acquires the electric signal thus measured together with time information and stores the electric signal and the time information into the memory. At this time, the acquirer 104 preferably stores the electric signal into the memory together with position information on the feed mechanism. The electrical signal stored into the memory may be a digital value obtained by A/D converting the voltage waveform. When the acquirer 104 acquires a predetermined number of voltage pulses, the movement controller 103 stops the relative movement of the cutting tool 20 and the workpiece 30 in the depth-of-cut direction, and stops the cutting that has been performed for the process (setup) of specifying the relative positional relationship. When the acquirer 104 acquires the predetermined number of voltage pulses, the movement controller 103 may stop cutting by relatively moving the cutting tool 20 and the workpiece 30 in a direction in which the cutting tool 20 and the workpiece 30 are separated from each other. At this time, setting the depth of cut less than an actual machining allowance (for example, a depth of cut applied to a finishing process) makes it possible to prevent cutting marks generated at the time of setup from remaining on a final machined surface.

In the first embodiment, the processor 105 has a function of specifying a position at which the workpiece 30 has reached the rotation locus circle of the outermost peripheral point of the cutting tool 20 from signals of one or a plurality of voltage pulses. Note that the position at which the workpiece 30 has reached the rotation locus circle may be a position of the workpiece 30 relative to the rotation center position when the rotation locus circle comes into contact with the contact surface of the workpiece 30 shown in FIG. 3. A description will be given below of a specifying process based on one voltage pulse signal and a specifying process based on a plurality of voltage pulse signals.

### Specifying Process Using One Voltage Pulse P₁

The processor 105 can specify a position at which the workpiece 30 has reached the rotation locus circle of the outermost peripheral point of the cutting tool 20 from one voltage pulse P₁. With reference to FIG. 3, when the cutting tool 20 and the workpiece 30 first come into contact with each other, the processor 105 derives a depth (maximum depth) of cut d by which the tool tip (cutting edge) of the cutting tool 20 cuts into the contact surface of the workpiece 30, so that the position at which the workpiece 30 has reached the rotation locus circle of the outermost peripheral point of the cutting tool 20 can be specified.

The processor 105 specifies a time section (continuity period) during which the cutting tool 20 and the workpiece 30 are in contact with each other from the electric signal acquired by the acquirer 104 and stored in the memory. The time section specified here is a pulse width W₁ of the voltage pulse P₁. The processor 105 calculates a ratio of the pulse width W₁ of the voltage pulse P₁ to a rotation period T of the cutting tool 20, that is, a duty cycle (W₁/T). When a rotation synchronization signal such as an encoder output is available, the processor 105 may obtain the rotation period T from the rotation synchronization signal. However, when the rotation synchronization signal is not available, an interval between the midpoint of the pulse width W₁ of the voltage pulse P₁ and the midpoint of the pulse width W₂ of the voltage pulse P₂ adjacent to the voltage pulse P₁ may be regarded as the rotation period T.

When the shapes and relative positions of the workpiece 30 and the cutting tool 20 are known, a relationship between the depth of cut d and the duty cycle D can be derived as follows. For example, when a helix angle of an end mill tool that comes into contact is zero degrees, and the contact surface of the workpiece 30 is a flat surface parallel to the tool rotation axis as shown in FIG. 3, an angle section (angle range) 2θ by which the cutting tool 20 comes into contact with the workpiece 30 with respect to the depth of cut d by which the surface of the workpiece 30 is cut is derived as follows.
With R: tool tip radius, d: depth of cut, and θ: one-side contact angle, cos θ=(R−d)/R is derived from the right triangle.
Accordingly, the depth of cut d is

d=R(1−cos θ).
The contact angle section 2θ is calculated as follows:

2θ=2 cos⁻¹{(R−d)/R}.

Therefore, the duty cycle D (=2θ/2π), which is the ratio of the contact angle section 2θ to one rotation, is calculated as follows:

$$D = ( {cos}^{- 1} \frac{R - d}{R} ) / π \qquad EXPRESSION ( 1 )$$

Here, for a duty cycle for a time section during which the cutting tool 20 and the workpiece 30 are in contact with each other,
a relationship of D=W₁/T is derived, so that the depth of cut d is calculated as follows:

$$d = R ( 1 - cos \frac{{W}_{1} π}{T} ) \qquad EXPRESSION ( 2 )$$

As described above, the processor 105 can derive, from one voltage pulse P₁, the maximum depth d by which the rotation locus circle (see FIG. 3) of the outermost peripheral point of the cutting tool 20 enters the contact surface of the workpiece 30. Therefore, the processor 105 can specify the relative positional relationship between the cutting tool 20 and the workpiece 30 using the depth of cut d. Specifically, the processor 105 specifies that the rotation locus circle of the outermost peripheral point of the cutting tool 20 reaches the workpiece 30 at a position where the cutting tool 20 is moved by the distance d in the direction opposite to the tool feed direction. The position at which the rotation locus circle of the outermost peripheral point of the cutting tool 20 reaches the workpiece 30 corresponds to a cutting start position at which the cutting tool 20 starts to cut. Note that when the angle section 2θ by which the cutting tool 20 comes into contact with the workpiece 30 can be measured by an angle measurer using an encoder or the like, the maximum depth d may be derived from the angle section 2θ thus measured. Specifying Process Using Plurality of Voltage Pulses P₁ to P₁₀

The processor 105 can specify a position at which the workpiece 30 has reached the rotation locus circle of the outermost peripheral point of the cutting tool 20 from the plurality of voltage pulses P₁ to P₁₀. In the first embodiment, 10 voltage pulses are used, but a plurality of other voltage pulses may be used.

The processor 105 specifies a time section (continuity period) during which the cutting tool 20 and the workpiece 30 are in contact with each other from the time-series data of the electric signal acquired by the acquirer 104 and stored in the memory. Then, the processor 105 specifies the midpoint of the time section (pulse width) of each of the voltage pulses P₁ to P₁₀ to derive times t₁ to t₁₀. As described above, when the feed amount per rotation is minute relative to the tool tip radius R, the interval between times t₁ to t₁₀ can be substantially regarded as the rotation period T.

Note that when the rotation period of the cutting tool 20 can be specified with accuracy, a time tₙ (2≤n≤10) may be determined by (time t₁+rotation period T*(n−1)). Further, when the rotation synchronization signal such as an encoder output is available, the times t₂ to t₁₀ each corresponding to the rotation period and included in the time section of a corresponding one of the voltage pulses P₂ to P₁₀ may be determined with the time t₁ as the starting point.

For each time section, the processor 105 calculates the ratio of the time section to the rotation period T, that is, the duty cycle. For the single-point milling tool, the maximum value of the duty cycle is 50%, but when the feed amount cannot be regarded as being minute, the maximum value of the duty cycle may slightly exceed 50%.

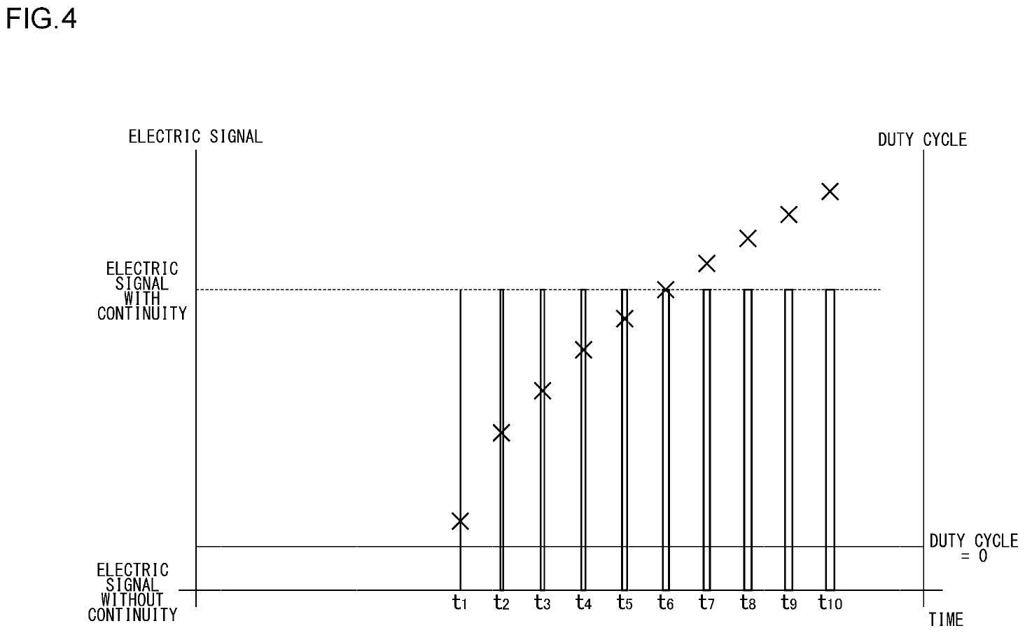

FIG. 4 is a diagram in which the duty cycle calculated for each time section is plotted with a cross mark on the times t₁ to t₁₀) corresponding to the rotation period T. The processor 105 performs statistical processing on the duty cycles of the plurality of time sections, subjects changes in the duty cycle to curve approximation, and obtains a time (time when the duty cycle becomes zero) at which the approximated regression curve (regression expression) zero-crosses.

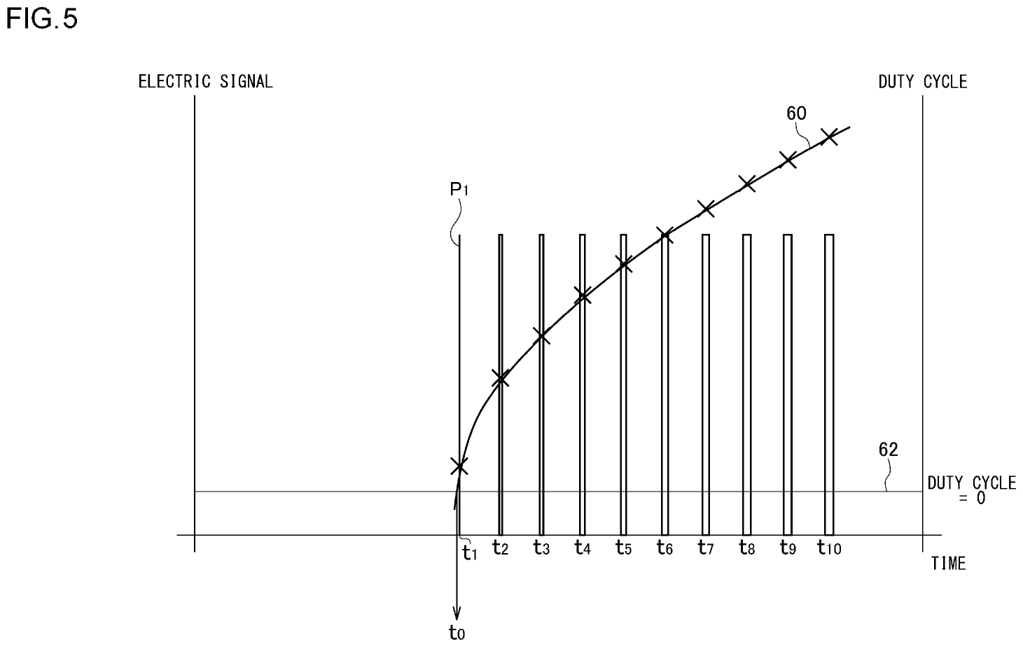

FIG. 5 shows an example of a regression curve 60 calculated by the processor 105. The processor 105 performs regression analysis on the duty cycles of the plurality of time sections to obtain the regression curve (regression expression) 60, and uses the regression curve 60 thus obtained to derive a position at which the contact surface of the workpiece 30 has reached the rotation locus circle of the outermost peripheral point of the cutting tool 20.

Specifically, the processor 105 obtains a time t₀ at which the duty cycle of the regression curve 60 thus calculated becomes zero. The time t₀ specified as an intersection of the regression curve 60 and a zero line 62 (duty cycle=0) is a time when the contact surface of the workpiece 30 has reached the rotation locus circle (see FIG. 3) of the outermost peripheral point of the cutting tool 20, that is, a time when the contact surface of the workpiece 30 comes into contact with the rotation locus circle. The position at which the rotation locus circle of the outermost peripheral point of the cutting tool 20 reaches the workpiece 30 corresponds to the cutting start position at which the cutting tool 20 starts to cut.

In the graph shown in FIG. 5, at the time t₀ corresponding to the cutting start position, a rotation angle position of the outermost peripheral point of the cutting tool 20 is not on the contact surface of the workpiece 30, and the cutting tool 20 and the workpiece 30 have yet to come into contact with each other. From the time t₀ to the leading edge of the voltage pulse P₁, the cutting tool 20 being rotating is fed toward the workpiece 30, and the cutting tool 20 and the workpiece 30 first come into contact with each other at the moment when the voltage pulse P₁ rises.

As described above, the processor 105 specifies a time section during which the cutting tool 20 and the workpiece 30 are in contact with each other from the time-series data of the electrical signal acquired by the acquirer 104 and specifies the time t₀ at which the workpiece 30 has reached the rotation locus circle of the outermost peripheral point of the cutting tool 20 from the plurality of time sections thus specified to specify the positions of the cutting tool 20 and the workpiece 30 at the time t₀. The processor 105 can derive an accurate cutting start position at which the cutting tool 20 starts to cut using the time-series data of the electric signal.

Note that, in the above-described example, the rotation speed of the spindle 10 is constant, and the feed rate of the workpiece 30 relative to the cutting tool 20 is constant; however, when the contact angle section 2θ can be measured by the angle measurer using an encoder or the like, the rotation speed of the spindle 10 need not necessarily be constant, and when the position information on the feed mechanism of the workpiece 30 relative to the cutting tool 20 can be measured, the feed rate need not necessarily be constant. In this case, the processor 105 may specify the angle section 2θ by which the cutting tool 20 and the workpiece 30 come into contact with each other, and specify the feed position at the workpiece 30 has reached the rotation locus circle of the outermost peripheral point of the cutting tool 20 from the plurality of angle sections thus specified.

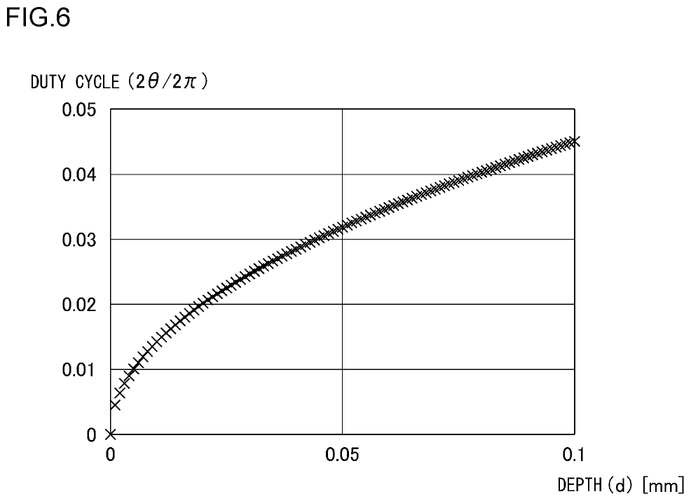

FIG. 6 shows a duty cycle calculated from the relational expression (1). In the graph shown in FIG. 6, the vertical axis represents the duty cycle (2θ/2π), and the horizontal axis represents the depth of cut d. Here, R=10 mm.

The processor 105 may derive the regression curve 60 (see FIG. 5) on the basis of the relational expression (1). For example, the processor 105 specifies a horizontal axis origin (a point on the zero line 62 (time t₀)) so as to minimize an error evaluation value (for example, a sum of squares of deviations) of the plurality of cross marks shown in FIG. 5 from the relational expression (1). As described above, the processor 105 obtains a relationship between the duty cycle and the depth of cut, and specifies the horizontal axis origin of the relational expression (1) so as to fit the plurality of duty cycles measured for each rotation period T, to specify the time t₀ at the moment when the workpiece 30 has reached the virtual rotation locus circle of the tool outermost peripheral point, so that the positions of the cutting tool 20 and the workpiece 30 at this time t₀ can be specified with accuracy.

Note that, in the above-described statistical processing, the sum of squares of deviations is used as the error evaluation value, but the processor 105 may specify the horizontal axis origin so as to minimize another error evaluation value, such as the sum of absolute values of errors.

Note that, in the example shown in FIG. 6, the tool tip radius R is known, but may be unknown. When the tool tip radius R is unknown, the processor 105 adjusts the value of the tool tip radius R so as to minimize the error evaluation value (for example, the sum of squares of deviations) of the plurality of cross marks shown in FIG. 5 from the relational expression (1) and then specifies the horizontal axis origin (point on the zero line 62 (time t₀)). In this case, the processor 105 can specify not only the horizontal axis origin of the relational expression (1) but also the tool tip radius R at the same time.

When the surface shape of the workpiece 30, the shape of the cutting tool 20, the relative positions of the workpiece 30 and the cutting tool 20, and the like are unknown, it may not be easy to derive a theoretical expression indicating the relationship between the depth of cut d and the duty cycle D. Even in such a case, for example, the horizontal axis origin t₀ can be specified by assuming a power function or a multi-order function and determining a factor that most matches the plurality of cross marks.

The relationship between the time on the horizontal axis and the relative position between the tool tip and the workpiece surface can be obtained using information in a control device of a machine tool. For example, the acquirer 104 stores the electric signal indicating whether contact is made into the memory together with the position information (measurement value or command value) on the feed mechanism that moves for contact operation, so that the processor 105 can specify the position at each time. In a case where it is difficult to perform the simultaneous storage, the acquirer 104 may store, into the memory in time series, a signal indicating whether contact is made at the time of approaching at a constant speed, and store, into the memory, position information at the moment when a command for stopping the approaching operation is made. The processor 105 can calculate the position of the section during which the tool tip is in contact with the workpiece surface using the electric signal stored in time series, the position information when the last electric signal is acquired, and the constant approach speed. Note that when the time information is stored in the memory, the processor 105 can calculate the position of the contact section using the electric signal stored in time series and the position information when the last electric signal is acquired.

In the above-described example, the case where the cutting tool 20 is a single-point rotary tool has been described. In a case of a rotary tool having a plurality of cutting edges, when eccentricity is extremely small (specifically, when the amount of eccentricity is smaller than the sum of depths of plowing and the feed amount per cutting edge), voltage pulses indicating contact are generated as many as the number of cutting edges at the maximum within one rotation period T. Here, the depth of plowing corresponds to a maximum value of a set depth of cut (that is, an amount of elastic deformation) when only abrading is performed without material removal due to the roundness of the tool tip. Therefore, when the depth is equal to or greater than the depth of plowing, material removal by the cutting edge is started. When the cutting tool 20 is a multi-point milling tool, and the amount of eccentricity is equal to or greater than the sum of depth of plowing and the feed amount per cutting edge, an inner cutting edge does not come into contact with a surface that an outer cutting edge has cut.

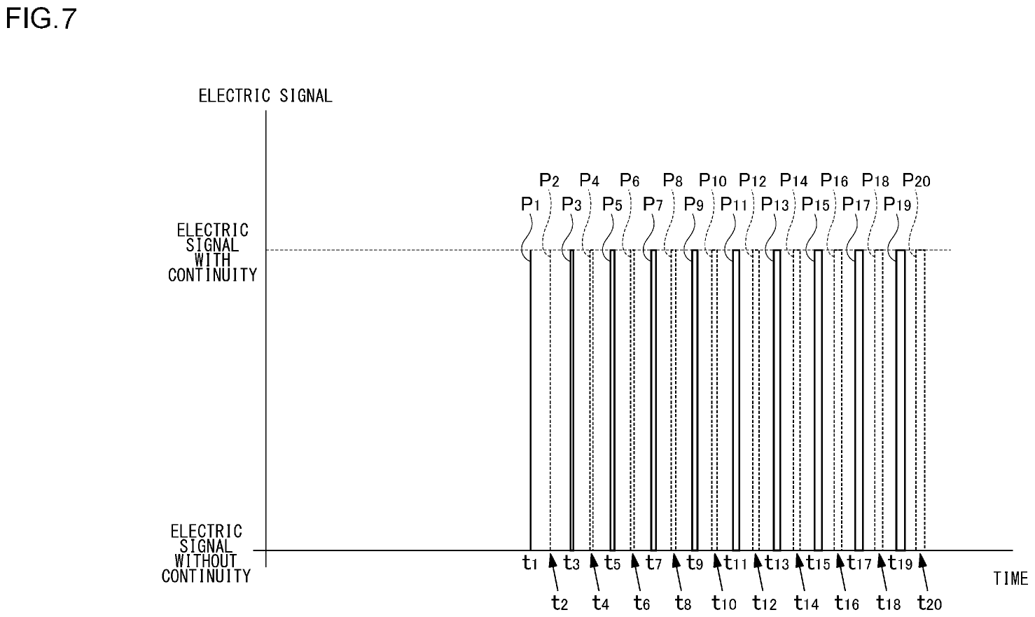

FIG. 7 shows an example of the electric signal measured by the measurer 45. During the measurement by the measurer 45, the rotation speed of the spindle 10 is constant, and the feed rate of the workpiece 30 relative to the cutting tool 20 is also constant. In a graph shown in FIG. 7, the vertical axis represents the electric signal (here, voltage signal) measured by the measurer 45, and the horizontal axis represents time when the cutting tool 20 and the workpiece 30 are relatively moved (brought close to each other) at the constant feed rate. Note that when the feed rate is variable, the horizontal axis may represent a coordinate value of the feed mechanism 24. In the example shown in FIG. 7, the cutting tool 20 being used is a two-point milling tool. Here, one of the two cutting edges is referred to as a first cutting edge, and the other cutting edge is referred to as a second cutting edge, and a tool tip radius R1 of the first cutting edge is greater than a tool tip radius R2 of the second cutting edge due to eccentricity.

When the two-point milling tool starts to cut the workpiece 30, as shown in FIG. 7, the contact monitor 40 detects continuity only when the tool cutting edge is in contact with the workpiece 30, and specifically, the measurer 45 measures pulsed voltages P₁ to P₂₀. The voltage pulses P₁, P₃, P₅, P₇, P₉, P₁₁, P₁₃, P₁₅, P₁₇, P₁₉ correspond to a waveform measured when the first cutting edge comes into contact with the workpiece 30, and the voltage pulses P₂, P₄, P₆, P₈, P₁₀, P₁₂, P₁₄, P₁₆, P₁₅, P₂₀ correspond to a waveform measured when the second cutting edge comes into contact with the workpiece 30.

Returning to FIG. 1, the measurer 45 measures the electric signal (voltage signal) indicating whether the cutting tool 20 and the workpiece 30 are in contact with each other and supplies the electric signal to the controller 100, and the acquirer 104 acquires the electric signal thus measured together with time information and stores the electric signal and the time information into the memory. The processor 105 specifies a time section (continuity period) during which the cutting tool 20 and the workpiece 30 are in contact with each other from the time-series data of the electric signal acquired by the acquirer 104 and stored in the memory. Then, the processor 105 specifies the midpoint of the time section (pulse width) of each of the voltage pulses P₁ to P₂₀ to derive times t₁ to t₂₀. Each interval between the midpoint timings t₁, t₃, t₅, t₇, t₉, t₁₁, t₁₃, t₁₅, t₁₇, t₁₉ of the voltage pulses related to the first cutting edge may be substantially regarded as the rotation period T, and each interval between the midpoint timings t₂, t₄, t₆, t₈, t₁₀, t₁₂, t₁₄, t₁₆, t₁₈, t₂₀ of the voltage pulses related to the second cutting edge may be substantially regarded as the rotation period T. Note that, as for how to determine the time tₙ, the rotation period T may be used when the rotation period T can be specified with accuracy, or the timing of the rotation synchronization signal may be used when the rotation synchronization signal is available.

For each time section, the processor 105 calculates the ratio of the time section to the rotation period T, that is, the duty cycle.

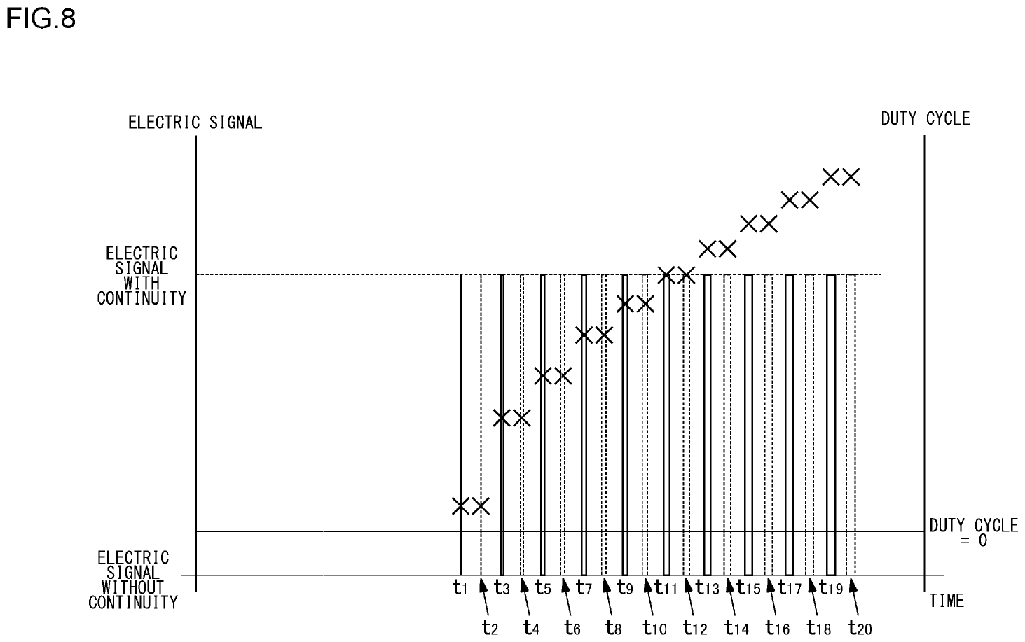

FIG. 8 is a diagram in which the duty cycle calculated for each time section is plotted with a cross mark on the times t₁ to t₂₀. The processor 105 performs statistical processing on the plurality of duty cycles calculated for the first cutting edge and the plurality of duty cycles calculated for the second cutting edge, subjects changes in their respective duty cycles to curve approximation, and obtains a time (time when the duty cycle becomes zero) at which the approximated regression curve (regression expression) zero-crosses.

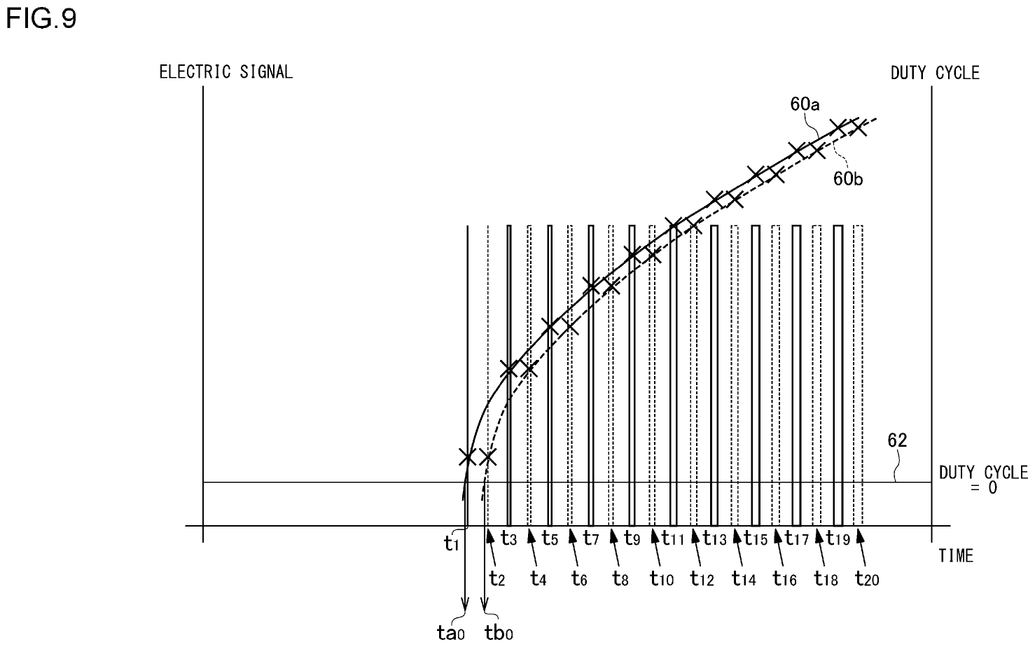

FIG. 9 shows examples of regression curves 60a, 60b calculated by the processor 105. Note that the regression curve 60a is a curve indicating temporal changes in the duty cycle of the first cutting edge, and the regression curve 60b is a curve indicating temporal changes in the duty cycle of the second cutting edge. As described above, the processor 105 may derive the regression curves 60a, 60b on the basis of the relational expression (1).

The processor 105 obtains times ta₀, tb₀ at which the duty cycles of the regression curves 60a, 60b thus calculated become zero. The time ta₀ specified as an intersection of the regression curve 60a and the zero line 62 (duty cycle=0) is a time when the workpiece 30 has reached the rotation locus circle (tool tip radius R1) of the outermost peripheral point of the first cutting edge of the cutting tool 20, that is, a time when the contact surface of the workpiece 30 comes into contact with the rotation locus circle (tool tip radius R1). Further, the time tb₀ specified as an intersection of the regression curve 60b and the zero line 62 (duty cycle=0) is a time when the workpiece 30 has reached the rotation locus circle (tool tip radius R2) of the outermost peripheral point of the second cutting edge of the cutting tool 20, that is, a time when the contact surface of the workpiece 30 comes into contact with the rotation locus circle (tool tip radius R2). Here, a difference between the time ta₀ and the time tb₀ is a value corresponding to the amount of eccentricity between the first cutting edge and the second cutting edge. The processor 105 may specify the amount of eccentricity from the difference between the time ta₀ and the time tb₀.

Note that, in this example, the second cutting edge comes into contact with the workpiece 30 under a condition where the amount of eccentricity is less than the sum of the depth of plowing and the feed amount per cutting edge, and as a result, the processor 105 can specify the amount of eccentricity. Conversely, the processor 105 can specify the amount of eccentricity by increasing the feed amount per cutting edge. Specifically, the processor 105 can specify not only the relative positional relationship between the cutting tool 20 and the workpiece 30 but also the amount of eccentricity of the cutting tool 20 attached to the spindle 10 by setting the feed amount per cutting edge to allow the inner cutting edge to come into contact with the surface that the outer cutting edge has cut.

In general, the tool tip radius R is an accurate value within tolerance, and is often measured in advance by a tool presetter or the like. However, when the tool is attached to a holder, and the holder is further attached to a machine tool spindle, eccentricity often occurs, which causes a machining error. Further, there is an error in the attachment (fixing) position of the workpiece, so that origin setting (setup) of offsetting (correcting) the machining origin is required. On the other hand, under the present method, it is possible to simultaneously specify the amount of eccentricity and the origin as described above, so that it is possible to not only increase the machining accuracy but also automate the setup or reduce labor required for the setup by correcting a tool diameter in accordance with the amount of eccentricity and correcting (offsetting) the machining origin in accordance with the cutting start position.

Note that, in the above-described example, the processor 105 calculates, for each time section, the ratio (duty cycle) of the time section to the rotation period T. When the rotation speed of the spindle 10 is constant, and the feed rate of the workpiece 30 relative to the cutting tool 20 is constant, the processor 105 may perform statistical processing on the lengths (pulse widths) of the plurality of time sections without calculating the duty cycle. In this case, the processor 105 may derive the relative positional relationship between the cutting tool 20 and the workpiece 30 by subjecting changes in the pulse width to curve approximation and obtaining the time when the approximated regression curve zero-crosses (time when the duty cycle becomes zero).

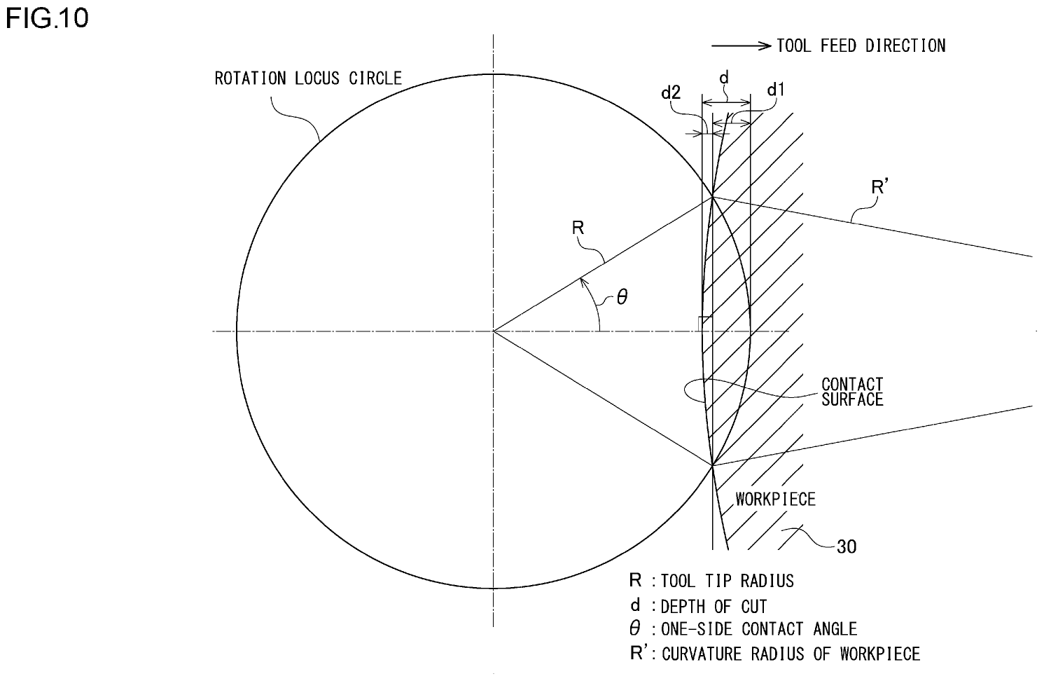

FIG. 10 schematically shows a state where the tool cutting edge comes into contact with the workpiece. As compared with FIG. 3, the contact surface of the workpiece 30 with which the tool tip comes into contact is not a flat surface but a curved surface having a curvature radius R′. In FIG. 10, the tool tip radius R indicates a radius of an outermost peripheral point of the cutting tool 20 (a tool tip position located at the outermost periphery during rotation), and thus a rotation locus circle represents a rotation locus of the tool outermost peripheral point.

For example, when a helix angle of an end mill tool that comes into contact is zero degrees, and the contact surface of the workpiece 30 is a curved surface having the radius R′ as shown in FIG. 10, an angle section 2θ by which the cutting tool 20 comes into contact with the workpiece 30 relative to the maximum depth of cut d (=d₁+d₂) by which the surface of the workpiece 30 is cut is derived as follows:
R: tool tip radius, d: depth of cut, θ: one-side contact angle, and R′: curvature radius of workpiece.

cos θ=(R−d₁)/R is derived from the right triangle on the tool side,
accordingly,

d₁=R(1−cos θ) is derived,
the base of the right triangle on the tool side coincides with the base of the right triangle on the workpiece side, so that

R²−(R−d₁)²=R′²−(R′−d₂)² is derived,
solving this expression for d₁ results in d=d₁+d₂, so that

d₁=(2dR′−d₂)/(2(R+R′−d)),
thus,

R(1−cos θ)=(2dR′−d₂)/2(R+R′−d) holds, and the contact angle section 2θ is calculated as follows:

$$2 θ = 2 {cos}^{- 1} ( 1 - \frac{2 {dR}^{′} - {d}^{2}}{2 R ( R + {R}^{′} - d )} ) \qquad EXPRESSION ( 3 )$$

Therefore, the duty cycle D (=2θ/2π), which is the ratio of the contact angle section 2θ to one rotation, is calculated as follows:

$$D = \frac{1}{π} {cos}^{- 1} ( 1 - \frac{2 {dR}^{′} - {d}^{2}}{2 R ( R + {R}^{′} - d )} ) \qquad EXPRESSION ( 4 )$$

Further, the depth of cut d is calculated as follows:

d=R(1−cos θ)+R′−\sqrt{R′²−R²(1−cos θ)} EXPRESSION (5)

As described above, when the contact surface of the workpiece 30 has the curvature radius, the processor 105 can derive, from one voltage pulse P₁, the depth of cut d by which the rotation locus circle (see FIG. 10) of the outermost peripheral point of the cutting tool 20 cuts into the contact surface of the workpiece 30 using the relational expression (5). The processor 105 may determine the horizontal axis origin from the plurality of voltage pulses P₁ to P₁₀ using the relational expression (4) to specify the position at which the workpiece 30 has reached the rotation locus circle of the outermost peripheral point of the cutting tool 20.

### Second Embodiment

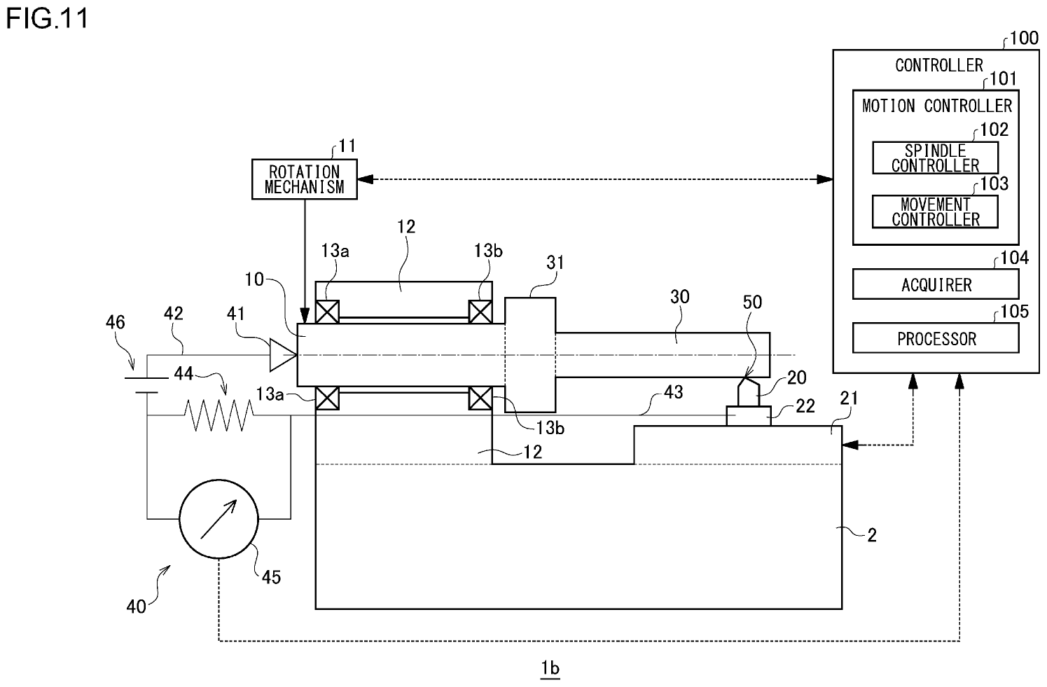

FIG. 11 shows a schematic structure of a cutting apparatus 1b according to a second embodiment. The cutting apparatus 1b has a function of bringing, in order to specify a relative positional relationship between a cutting tool 20 and a workpiece 30, the cutting tool 20 and the workpiece 30 into contact with each other before starting a full-scale cutting process to derive the relative positional relationship. The cutting apparatus 1b according to the second embodiment includes a component identical or similar in structure and function to a corresponding component of the cutting apparatus 1a according to the first embodiment, the component being denoted by the same reference numeral as the corresponding component of the cutting apparatus 1a.

The cutting apparatus 1b is a lathe or a turning center that rotates the workpiece 30 attached to a spindle 10 by a chuck 31 to cause the cutting edge of the cutting tool 20 to cut into the workpiece 30 being rotating. In the second embodiment, the spindle 10, the chuck 31, the workpiece 30, the cutting tool 20 and a tool fixing part 22 are conductors, and the cutting edge of the cutting tool 20 cuts the workpiece 30 at a cutting point 50.

The cutting apparatus 1b includes, on a bed 2, a spindle housing 12, and a feed mechanism 21 that moves the cutting tool 20 relative to the workpiece 30. The cutting tool 20 is fixed to the tool fixing part 22, and the tool fixing part 22 is supported by the feed mechanism 21 in a movable manner. In the cutting apparatus 1b, the feed mechanism 21 moves the tool fixing part 22 in the X-axis, Y-axis, and Z-axis directions to move the cutting tool 20 relative to the workpiece 30. The feed mechanism 21 may include a motor and a ball screw for each axis.

The spindle 10 is supported by the spindle housing 12 in a rotatable manner, and specifically, bearings 13a, 13b made of metal and fixed to the spindle housing 12 support the spindle 10 in a rotatable manner. A rotation mechanism 11 includes a mechanism that rotates the spindle 10, and includes a motor and a transmission structure that transmits rotational power of the motor to the spindle 10. The cutting apparatus 1b includes a voltage application unit 46 that applies a predetermined voltage between the cutting tool 20 and the workpiece 30. A contact monitor 40 monitors the presence or absence of continuity established when the cutting tool 20 and the workpiece 30 come into contact with each other. Note that the contact monitor 40 may include an electric resistance 47 (see FIG. 1) provided between a conducting wire 42 and a conducting wire 43, and monitor a change in voltage caused when the cutting tool 20 and the workpiece 30 come into contact with each other.

In general, the workpiece 30 is attached to the spindle 10 with minute eccentricity. A description will be given below of a method for deriving a relative positional relationship between the cutting tool 20 and the workpiece 30 in the cutting apparatus 1b according to the second embodiment. Under this method, with the workpiece 30 rotating, the cutting tool 20 is moved relative to the workpiece 30 in the X-axis direction (up-down direction), and time-series data of the electric signal measured by the measurer 45 after the tool cutting edge starts to cut into (or come in contact with) the workpiece 30 is analyzed to derive the relative positional relationship.

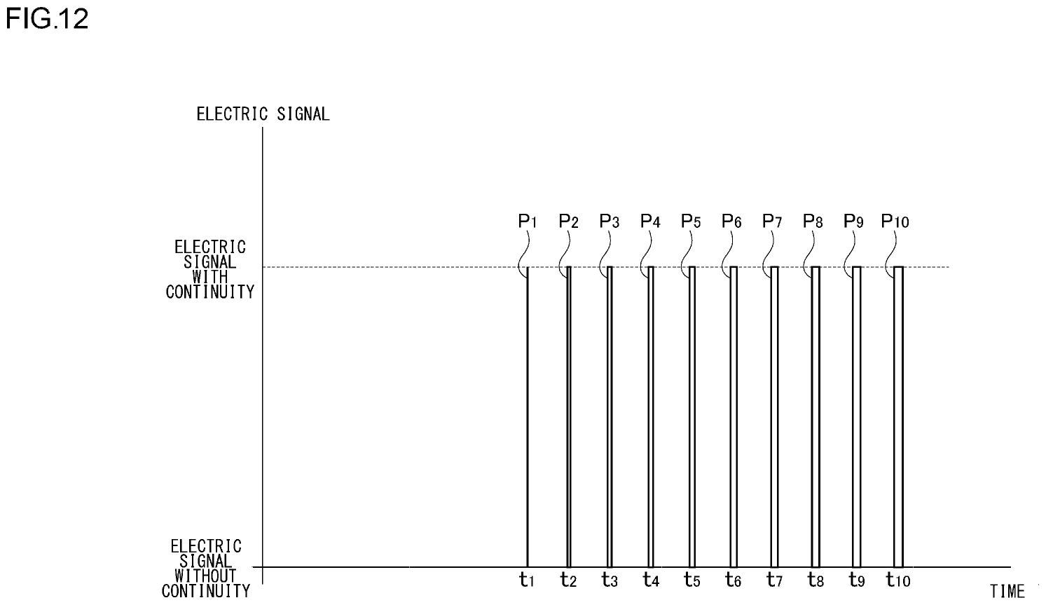

FIG. 12 shows an example of the electric signal measured by the measurer 45. During the measurement by the measurer 45, the rotation speed of the spindle 10 is constant, and the feed rate of the workpiece 30 relative to the cutting tool 20 is also constant. The measurer 45 measures an electric signal indicating whether the cutting tool 20 and the workpiece 30 are in contact with each other. In a graph shown in FIG. 12, the vertical axis represents the electric signal (here, voltage signal) measured by the measurer 45, and the horizontal axis represents time when the cutting tool 20 and the workpiece 30 are relatively moved (brought close to each other) at the constant feed rate. Note that when the feed rate is variable, the horizontal axis may represent a coordinate value of the feed mechanism 21. In the second embodiment, it is assumed that the workpiece 30 is eccentrically attached to the spindle 10, and when the cutting tool 20 is fed in the depth-of-cut direction of the workpiece 30, the cutting tool 20 periodically cuts the workpiece 30.

When the cutting tool 20 starts to cut the workpiece 30, as shown in FIG. 12, the contact monitor 40 detects electrical continuity only when the tool cutting edge is in contact with the workpiece 30, and specifically, the measurer 45 measures pulsed voltages P₁ to P₁₀. The continuity period (pulse width) corresponds to an angle by which the tool cutting edge comes into contact with the workpiece 30, and the larger the contact angle viewed from the rotation center, the longer the continuity period. Note that, in a case that the electric resistance 47 serving as an anti-noise resistance is provided in the electric circuit, when the tool cutting edge is in contact with the workpiece 30, the measurer 45 measures a voltage different from a voltage which is measured when the tool cutting edge is out of contact with the workpiece 30.

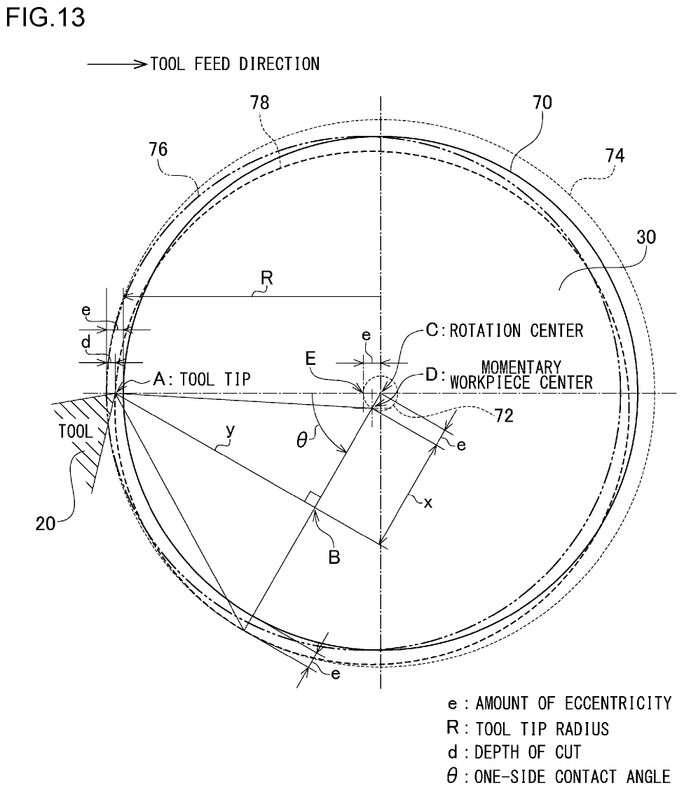

FIG. 13 schematically shows a state where the tool cutting edge comes into contact with a workpiece having a cylindrical surface. When the surface of the workpiece 30 with which contact is made can be regarded as a cylindrical surface (a peeling material, a drawing material, or a centerless material, which is often used as a metal material of a round bar, being high in circularity as compared with the amount of eccentricity at the time of chucking), and the feed amount per rotation is minute relative to an amount of eccentricity e, a period of the midpoint of the continuity period almost coincides with the rotation period T of the spindle 10. In FIG. 13, a workpiece surface 70 indicates a workpiece outer peripheral surface when the workpiece 30 is attached to the spindle 10 without eccentricity. In the second embodiment, the workpiece 30 is eccentrically attached to the spindle 10 and has the amount of eccentricity e in a state shown in the figure. Note that the closer the contact position to the chuck 31, the smaller the amount of eccentricity e, and the farther the contact position from the chuck 31, the larger the amount of eccentricity.

The center of the workpiece 30 rotationally moves, along a center locus 72 having a radius equal to the amount of eccentricity e, around a rotation center C of the spindle 10. In FIG. 13, a rotation locus circle 74 having a radius equal to (the workpiece radius R+the amount of eccentricity e) represents a rotation locus drawn by the outermost peripheral point of the workpiece surface. Here, a workpiece surface 76 indicates a workpiece outer peripheral surface when the center of the workpiece 30 coincides with a point E, and a workpiece surface 78 indicates a workpiece outer peripheral surface when the center of the workpiece 30 coincides with a point D. In FIG. 12 showing 10 voltage pulses P₁ to P₁₀ measured in time series, as the depth of the cut increases with time, the contact angle section (2θ) increases, and the pulse width of the voltage pulse increases.

Returning to FIG. 11, the measurer 45 measures the electric signal (voltage signal) indicating whether the cutting tool 20 and the workpiece 30 come into contact with each other and supplies the electric signal to the controller 100, and the acquirer 104 acquires the electric signal thus measured together with time information and/or position information and stores the electric signal and the information into the memory. The processor 105 specifies a time section (continuity period) during which the cutting tool 20 and the workpiece 30 are in contact with each other from the time-series data of the electric signal acquired by the acquirer 104 and stored in the memory. The processor 105 specifies the midpoint of the time section (pulse width) of each of the voltage pulses P₁ to P₁₀ to derive times t₁ to t₁₀. When the surface of the workpiece 30 can be regarded as a cylindrical surface, and the feed amount per rotation is minute relative to the radius R of the workpiece 30, the interval between times t₁ to t₁₀ can be substantially regarded as the rotation period T. Note that, as for how to determine the time tₙ, the rotation period T may be used when the rotation period T can be specified with accuracy, or the timing of the rotation synchronization signal may be used when the rotation synchronization signal is available.

For each time section, the processor 105 calculates the ratio of the time section to the rotation period T, that is, the duty cycle.

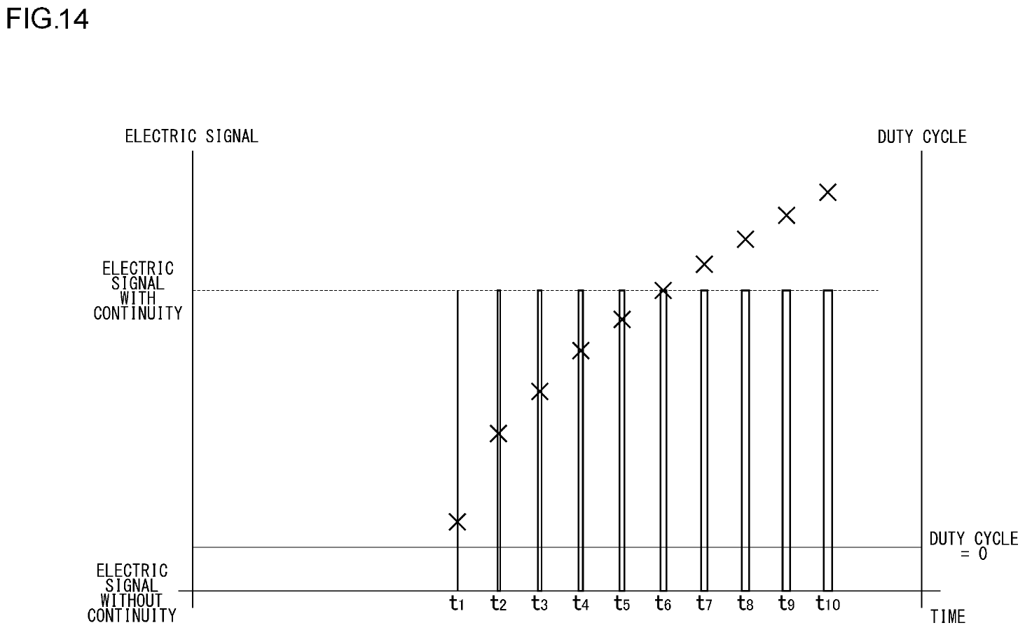

FIG. 14 is a diagram in which the duty cycle calculated for each time section is plotted with a cross mark on the times t₁ to t₁₀ corresponding to the rotation period T. The processor 105 performs statistical processing on the duty cycles of the plurality of time sections, subjects changes in the duty cycle to curve approximation, and obtains a time (time when the duty cycle becomes zero) at which the approximated regression curve (regression expression) zero-crosses.

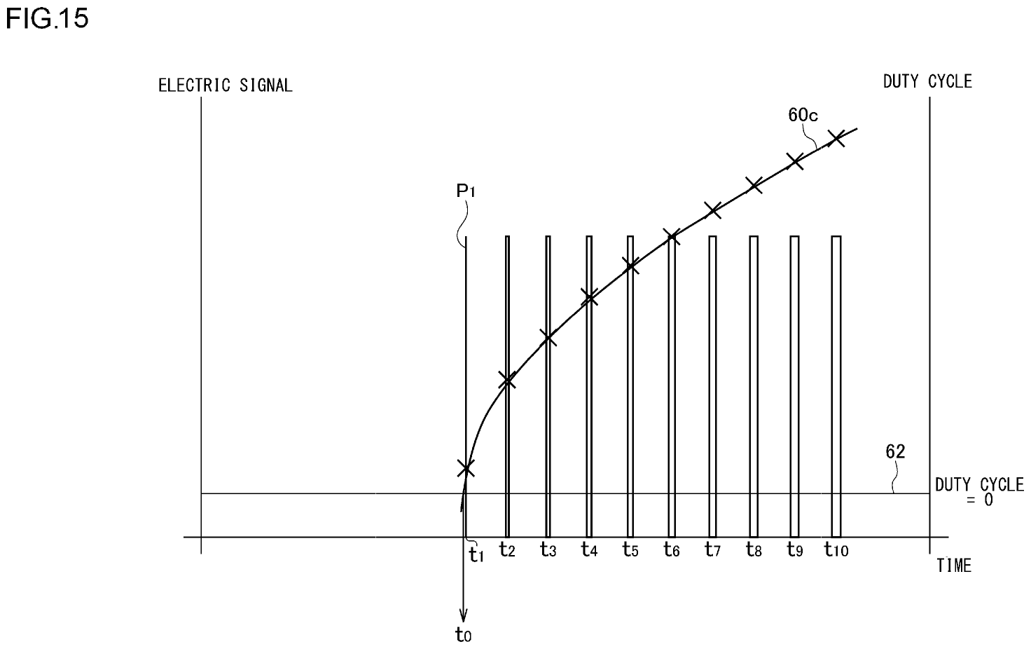

FIG. 15 shows an example of a regression curve 60c calculated by the processor 105. The processor 105 obtains a time t₀ at which the duty cycle of the regression curve 60c thus calculated becomes zero. The time t₀ specified as an intersection of the regression curve 60c and the zero line 62 (duty cycle=0) is a time when the cutting tool 20 has reached the rotation locus circle 74 (see FIG. 13) of the outermost peripheral point of the workpiece 30, that is, a time when a tool tip A of the cutting tool 20 comes into contact with the rotation locus circle, and the cutting tool 20 and the workpiece 30 have yet to come into contact with each other at the time t₀. From the time t₀ to the leading edge of the voltage pulse P₁, the cutting tool 20 is fed toward the workpiece 30 being rotating, and the cutting tool 20 and the workpiece 30 first come into contact with each other at the moment when the voltage pulse P₁ rises.

As described above, the processor 105 specifies a time section during which the cutting tool 20 and the workpiece 30 are in contact with each other from the time-series data of the electrical signal acquired by the acquirer 104 and specifies the time t₀ at which the cutting tool 20 has reached the rotation locus circle 74 of the outermost peripheral point of the workpiece 30 from the plurality of time sections thus specified to specify the positions of the cutting tool 20 and the workpiece 30 at the time t₀. The processor 105 can derive an accurate cutting start position at which the cutting tool 20 starts to cut using the time-series data of the electric signal.

With reference to FIG. 13, the contact angle section 2θ increases as the depth of cut from the surface of the workpiece 30 increases. With e: amount of eccentricity, R: radius of workpiece, d: depth of cut, and θ: one-side contact angle,

(R+e−d)²=(e+x)²+y² is derived from the right triangle ABC,
similarly,

R²=x²+y² is derived from the right triangle ABD,
solving the two expressions simultaneously for x results in x=R−d+(d²−2dR)/(2e), and
therefore, the contact angle section 2θ is calculated as follows:

$$2 θ = 2 {cos}^{- 1} \frac{e + x}{R + e - d} = 2 {cos}^{- 1} ( 1 - \frac{d ( 2 R - d )}{2 e ( R + e - d )} ) \qquad EXPRESSION ( 6 )$$

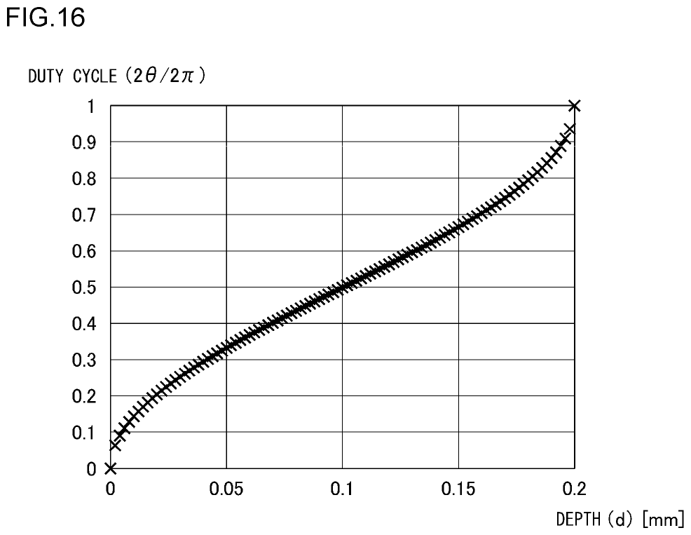

FIG. 16 shows a duty cycle calculated from the relational expression (6). In the graph shown in FIG. 16, the vertical axis represents the duty cycle (2θ/2π), and the horizontal axis represents the depth of cut d. Here, it is assumed that the radius R of the workpiece and the amount of eccentricity e are known, and R=10 mm and e=0.1 mm.

The processor 105 may derive the regression curve 60c (see FIG. 15) on the basis of the relational expression (6). For example, the processor 105 specifies a horizontal axis origin (a point on the zero line 62 (time t₀)) so as to minimize an error evaluation value (for example, a sum of squares of deviations) of the plurality of cross marks shown in FIG. 15 from the relational expression (6). As described above, the processor 105 obtains the relational expression (6) indicating a relationship between the contact angle section and the depth of cut, and specifies the horizontal axis origin of the relational expression (6) so as to fit the plurality of duty cycles measured for each rotation period T to specify the time t₀ at the moment when the cutting tool 20 has reached the virtual rotation locus circle of the workpiece outermost peripheral point, so that the positions of the cutting tool 20 and the workpiece 30 at this time t₀ can be specified with accuracy.

Note that, in the above-described statistical processing, the sum of squares of deviations is used as the error evaluation value, but the processor 105 may specify the horizontal axis origin so as to minimize another error evaluation value, such as the sum of absolute values of errors.

In the example shown in FIG. 16, the amount of eccentricity e is known, but may be unknown. When the amount of eccentricity e is unknown, the processor 105 adjusts the value of the amount of eccentricity e so as to minimize the error evaluation value (for example, the sum of squares of deviations) of the plurality of cross marks shown in FIG. 15 from the relational expression (6) and then specifies the horizontal axis origin (point on the zero line 62 (time t₀)). In this case, the processor 105 can specify not only the horizontal axis origin of the relational expression (6) but also the amount of eccentricity e of the workpiece at the same time. Note that, the duty cycle becomes 1 when the depth of cut is at least twice the amount of eccentricity e, the processor 105 may specify the amount of eccentricity e by specifying the first time section in which the duty cycle becomes 1.

In general, round bar materials are typically finished to have an accurate diameter within tolerance. However, when such a material is attached to the chuck, the material is often made eccentric, and there is also an error in the attachment (fixing) position of the tool. Therefore, origin setting (setup) for offsetting the machining origin (tool length correction) is required. On the other hand, under the present method, the amount of eccentricity and the cutting start position can be simultaneously specified as described above, so that when the diameter of the material is known, the offset amount of the machining origin (tool length correction) can be obtained from the amount of eccentricity identified as the diameter and the cutting start position, and it is possible to not only increase the machining accuracy and but also automate the setup or reduce labor required for the setup.

### Third Embodiment

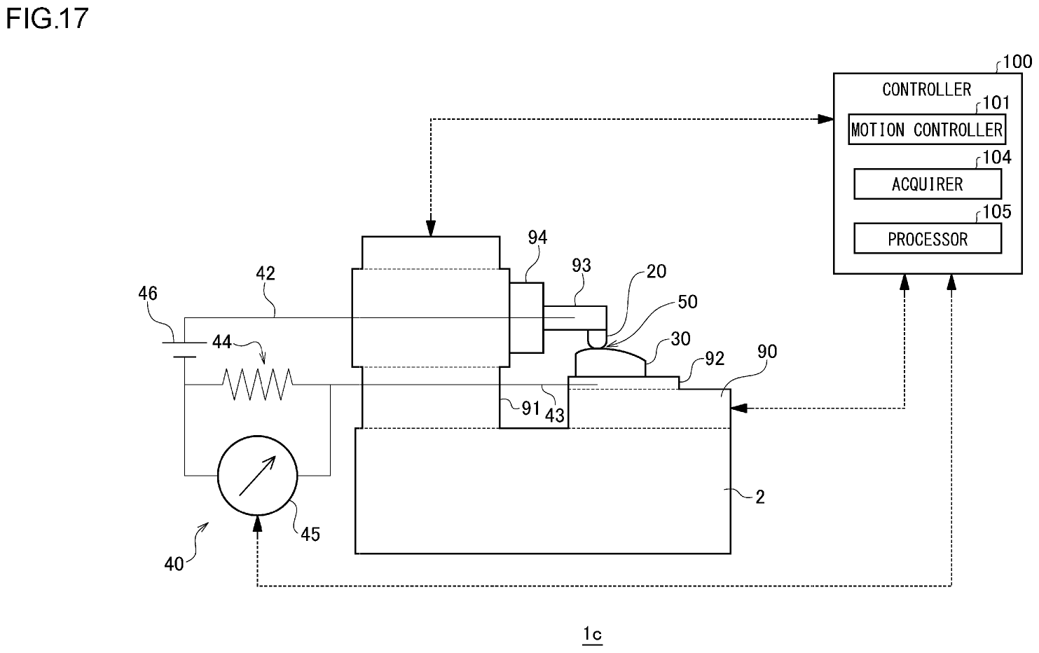

FIG. 17 shows a schematic structure of a cutting apparatus 1c according to a third embodiment. The cutting apparatus 1c has a function of bringing, in order to specify a relative positional relationship between a cutting tool 20 and a workpiece 30, the cutting tool 20 and the workpiece 30 into contact with each other before starting a full-scale cutting process to derive the relative positional relationship. The cutting apparatus 1c according to the third embodiment includes a component identical or similar in structure and function to a corresponding component of the cutting apparatus 1a according to the first embodiment, the component being denoted by the same reference numeral as the corresponding component of the cutting apparatus 1a.

Unlike the cutting apparatus 1a according to the first embodiment and the cutting apparatus 1b according to 10 the second embodiment, the cutting apparatus 1c according to the third embodiment has no spindle 10. The cutting apparatus 1c is a machine tool that performs free-form surface machining using a non-rotary tool, and may be a planing machine. In the third embodiment, a tool fixing part 93, the cutting tool 20, the workpiece 30, and a workpiece fixing part 92 are conductors, and the cutting edge of the cutting tool 20 cuts the workpiece 30 at a cutting point 50.

The cutting apparatus 1c includes, on a bed 2, feed mechanisms 90, 91 that move the cutting tool 20 relative to the workpiece 30. The workpiece 30 is fixed to the workpiece fixing part 92, and the workpiece fixing part 92 is supported by the feed mechanism 90 in a movable manner. The cutting tool 20 is fixed to the tool fixing part 93, and a tool base 94 to which the tool fixing part 93 is attached is supported by the feed mechanism 91 in a movable manner. In the cutting apparatus 1c, the feed mechanism 90 moves the workpiece fixing part 92 in the X-axis direction (front-rear direction), and the feed mechanism 91 moves the tool base 94 in a Y-axis direction (up-down direction) and the Z-axis direction (left-right direction), so as to move the cutting tool 20 relative to the workpiece 30. The feed mechanisms 90, 91 may each include a motor and a ball screw for each axis. Further, the tool base 94 may be supported in a C-axis (rotation axis around the Z-axis) direction in a rotatable manner (position-changeable manner), the workpiece fixing part 92 may be supported in a B-axis (rotation axis around the Y-axis) direction in a rotatable manner (position-changeable manner).

The cutting apparatus 1c includes a voltage application unit 46 that applies a predetermined voltage between the cutting tool 20 and the workpiece 30. A contact monitor 40 monitors whether the cutting tool 20 and the workpiece 30 are in contact with each other. The contact monitor 40 includes a conducting wire 42 electrically connected to the tool fixing part 93, a conducting wire 43 electrically connected to the workpiece 30, an electric resistance 44 provided between the conducting wire 42 and the conducting wire 43, and a measurer 45 that measures a voltage applied to the electric resistance 44. Note that the measurer 45 may have a function of measuring a current flowing through the electric resistance 44. In the cutting apparatus 1c, the conducting wire 43 is connected to the workpiece fixing part 92 that fixes the workpiece 30. The contact monitor 40 monitors the presence or absence of continuity established when the cutting tool 20 and the workpiece 30 come into contact with each other. Note that the contact monitor 40 may have an electric resistance 47 (see FIG. 1) provided between the conducting wire 42 and the conducting wire 43.

A controller 100 includes a motion controller 101 that controls motion of the cutting tool 20 and/or the workpiece 30, an acquirer 104 that acquires an electric signal measured by the measurer 45, and a processor 105 that specifies a relative positional relationship between the cutting tool 20 and the workpiece 30 from the electric signal acquired by the acquirer 104. The motion controller 101 has a function of moving the cutting tool 20 relative to the workpiece 30 in a direction in which the cutting tool 20 and the workpiece 30 come into contact with each other while imparting motion along a predetermined locus to one of the cutting tool 20 or the workpiece 30.

Each element described as a functional block of the controller 100 may be implemented, in terms of hardware, by a circuit block, a memory, other LSI, a CPU, and the like, and be implemented, in terms of software, by system software, an application program loaded into the memory, and the like. Therefore, it is to be understood by those skilled in the art that these functional blocks may be implemented in various forms such as hardware only, software only, or a combination of hardware and software, and how to implement the functional blocks is not limited to any one of the above.

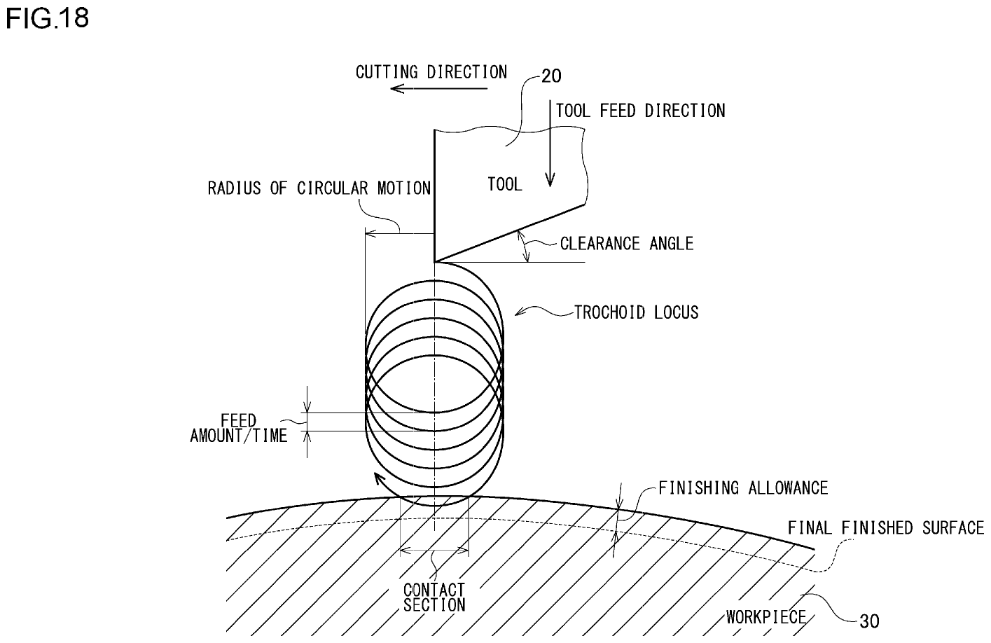

FIG. 18 schematically shows a state where the tool cutting edge comes into contact with the workpiece. The motion controller 101 imparts feed motion to the cutting tool 20 in a direction in which the cutting tool 20 and the workpiece 30 come into contact with each other while imparting the motion along the predetermined locus (hereinafter, also referred to as “locus motion”) to the cutting tool 20. The locus motion may be periodic motion including at least a component in motion direction opposite to the direction of the feed motion. The motion controller 101 imparts the locus motion and the feed motion to the cutting tool 20 without changing the position of the cutting tool 20 relative to the workpiece 30. In the third embodiment, the locus motion is not motion along only one linear locus (linear motion).

In this example, the motion controller 101 brings the cutting edge of the cutting tool 20 close to the workpiece 30 along a trochoid locus within a plane including the cutting direction and the depth-of-cut direction (tool feed direction at the time of setup) at the time of actual machining. It is preferable that the motion controller 101 cause the cutting tool 20 to cut the workpiece 30 at least once, and stop the locus motion of the cutting tool 20 and retract the cutting tool 20 before excessive cutting. Each feed amount may be set on the basis of the number of times of cutting, and (feed amount/time) is set less than or equal to (finishing allowance) when retracting after one cutting, and (feed amount/time) is set less than or equal to (finishing allowance/number of times of cutting) when retracting after a plurality of times of cutting.

Note that the motion controller 101 causes the tool cutting edge to most deeply cut into the workpiece along the motion locus immediately before performing the above-described retracting operation. During the contact period, the motion locus desirably has a downwardly convex shape. Further, in order to prevent a tool flank face from being damaged when being pressed against the workpiece, it is desirable that the downward angle (entry angle) of the locus be less than or equal to a tool clearance angle.

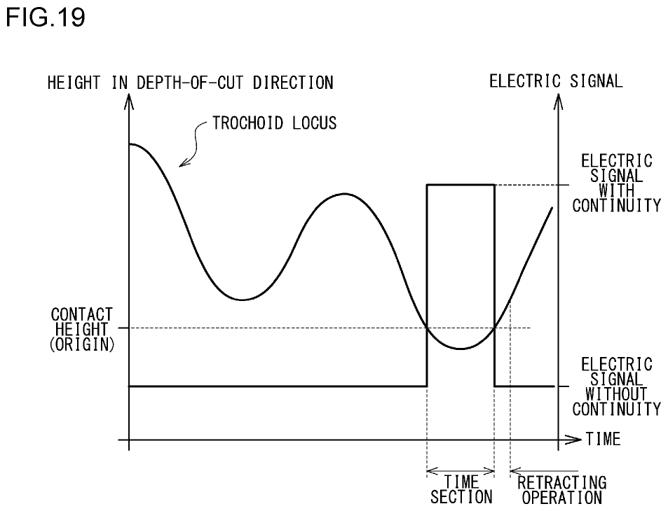

FIG. 19 is a diagram showing a relationship between the locus motion of the cutting edge and the electric signal measured by the measurer 45. When the cutting edge of the cutting tool 20 comes close to the workpiece 30 along the trochoid locus and comes into contact with the workpiece 30 at a contact height (origin), the measurer 45 measures the electric signal indicating that the cutting tool 20 and the workpiece 30 come into contact with each other. When the acquirer 104 acquires the electric signal indicating the contact, the processor 105 specifies a timing of the contact and specifies a relative positional relationship between the cutting tool 20 and the workpiece 30 at the timing thus specified, that is, the contact height (origin). Here, the contact height (origin) is a height of a premachined surface. When the section during which the cutting tool 20 and the workpiece 30 are in contact with each other ends, and the acquirer 104 acquires an electric signal indicating that the cutting tool 20 and the workpiece are out of contact with each other, the motion controller 101 may impart, to the cutting tool 20, feed motion in a direction in which the cutting tool 20 and the workpiece 30 are separated from each other. Note that when the acquirer 104 acquires the electric signal indicating that the cutting tool 20 and the workpiece 30 are out of contact with each other while continuously acquiring the electric signal indicating that the cutting tool and the workpiece 30 are in contact with each other, the processor 105 may specify a timing at which the cutting tool 20 and the workpiece 30 come out of contact with each other and specify a relative positional relationship between the cutting tool 20 and the workpiece 30 at the timing thus specified.

As described above, the motion controller 101 continues to impart the locus motion to at least one of the cutting tool 20 or the workpiece 30 from when the cutting tool 20 comes into contact with the workpiece 30 until when the cutting tool 20 comes out of contact with the workpiece 30. The locus motion is not linear motion but includes a component in the cutting direction during actual machining, and the tool flank face is brought into contact with (scratches or cuts into) the workpiece 30 at an angle at which the tool flank face is not pressed against the workpiece, thereby preventing the tool from being damaged.

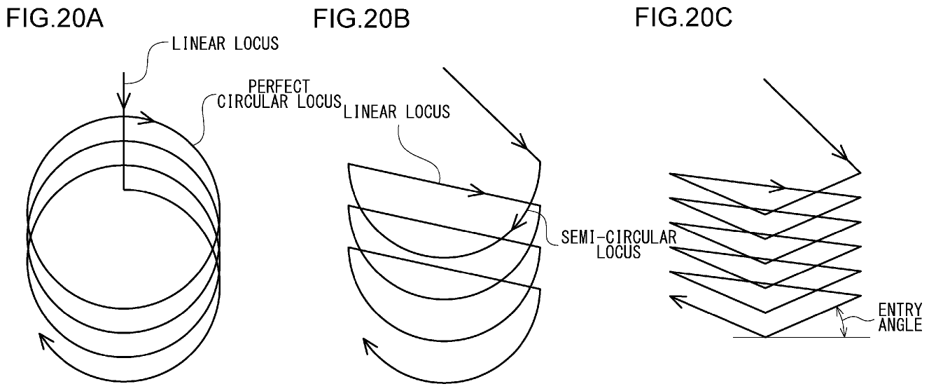

FIG. 20A is a diagram showing another example of the motion locus. The motion locus shown in FIG. 20A is a locus along which the cutting tool 20 is brought close to the workpiece 30 by alternately repeating perfect circular locus motion and linear locus motion.

FIG. 20B is a diagram showing another example of the motion locus. The motion locus shown in FIG. 20B is a locus along which the cutting tool 20 is brought close to the workpiece 30 by alternately repeating semi-circular locus motion and linear locus motion.

FIG. 20C is a diagram showing another example of the motion locus. The motion locus shown in FIG. 20C is a locus along which the cutting tool 20 is brought close to the workpiece 30 by repeating triangular locus motion formed by connecting a plurality of linear locuses.

As described above, in the third embodiment, the motion controller 101 brings the cutting tool 20 into contact with the workpiece 30 by imparting, to the cutting tool 20, the feed motion in the depth-of-cut direction while imparting the motion along the predetermined locus.

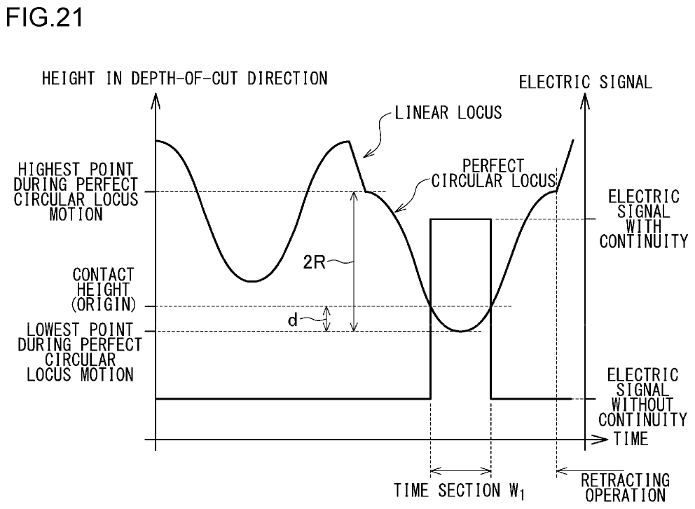

FIG. 21 is a diagram showing a relationship between the locus motion of the cutting edge and the electric signal measured by the measurer 45. The measurer 45 measures the electric signal indicating whether the cutting tool 20 and the workpiece 30 come into contact with each other, and the acquirer 104 stores, into a memory, the electric signal thus measured together with time information and/or position information. In the example shown in FIG. 21, the cutting edge of the cutting tool 20 is brought close to the workpiece 30 along the motion locus shown in FIG. 20A. That is, the cutting edge of the cutting tool 20 is brought close to the workpiece 30 by alternately repeating the perfect circular locus motion and the linear locus motion to cut the workpiece 30 once. While the cutting edge is in contact with the workpiece 30, the measurer 45 measures the electric signal indicating the contact (continuity).

The processor 105 specifies a time section (continuity period) W₁ during which the cutting tool 20 and the workpiece 30 are in contact with each other from the electric signals acquired by the acquirer 104 and stored in the memory. The processor 105 calculates a ratio of the time section W₁ to the period T of the perfect circular locus motion of the cutting edge, that is, a duty cycle (W₁/T). In FIG. 21, the contact height (origin) is a height of the premachined surface, and the distance from the contact height (origin) to the lowermost point of the perfect circular locus motion indicates a maximum depth of cut d. As described in the first embodiment, when the contact surface of the workpiece 30 is a flat surface, the processor 105 can calculate the depth of cut d using the relational expression (2). When the contact surface of the workpiece 30 is a curved surface, the processor 105 can calculate the depth of cut d using the relational expression (5). The acquirer 104 can calculate the contact height (origin) by adding the calculated d to the lowest point of the perfect circular locus motion.

When a multi-axis motion locus as shown in FIGS. 18 and/or 20A to 20C is generated using a feed mechanism of a numerical control (NC) machine tool, it is known that an inward cornering error occurs inside a corner or a circle. This is due to the fact that the acceleration limit caused by motor power is maintained and the machine tool performs filling to prevent the machine tool from vibrating. The inward cornering error during the generation of the multi-axis locus (processing before giving the target (command) value to the control device of each axis) is based on characteristics (characteristics of the filter) determined for each machine tool, the processor 105 can calculate a locus (inward cornering locus) including the inward cornering error in advance. Further, the inward cornering error in the actual motion locus may be measured in advance, and the inward cornering locus may be stored. That is, when the motion controller 101 generates the multi-axis motion locus, the processor 105 can acquire the inward cornering locus in advance or afterwards. In the third embodiment, when the motion controller 101 imparts locus motion to the cutting tool 20 to bring the cutting tool 20 and the workpiece 30 into contact with each other, the processor 105 can accurately obtain the depth of cut d by solving the relational expression (2) or (5) using the known inward cornering locus. In particular, when the motion locus has an arc shape with a small diameter, high speed motion is performed, and the filter time constant is long, the inward cornering error becomes large, and it is therefore preferable that the processor 105 obtain the depth of cut d using the inward cornering locus.

### Fourth Embodiment

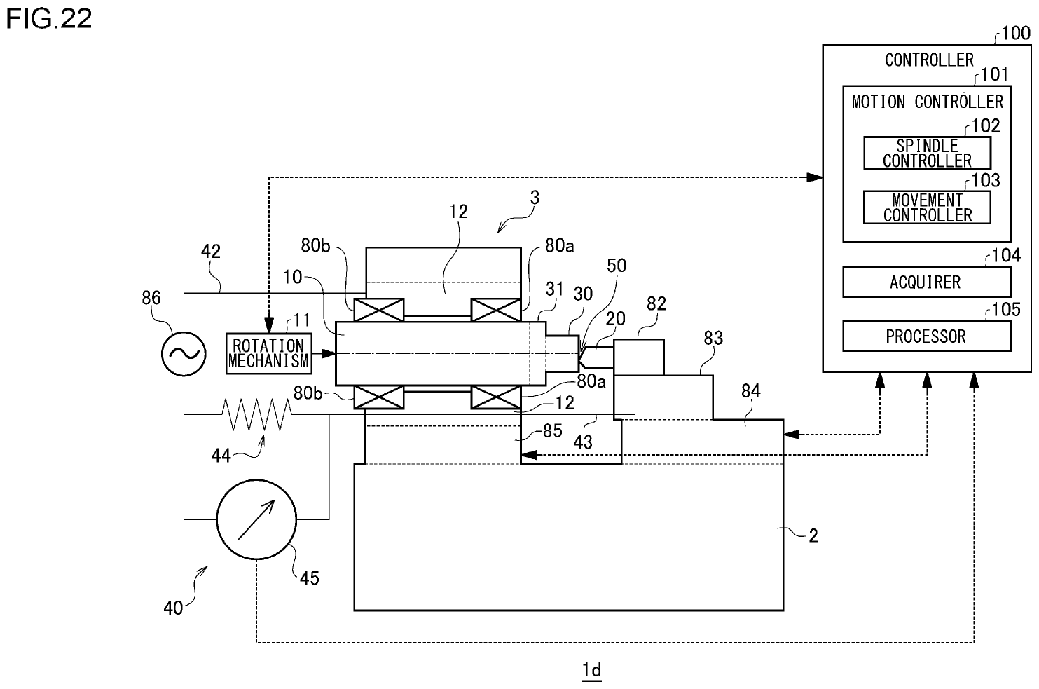

FIG. 22 shows a schematic structure of a cutting apparatus 1d according to a fourth embodiment. The cutting apparatus 1d is a lathe or a turning center that rotates a workpiece 30 attached to a spindle 10 with a chuck 31 interposed between the workpiece 30 and the spindle 10 to cause the cutting edge of a cutting tool 20 to cut into the workpiece 30 being rotating. In the fourth embodiment, the spindle 10, the chuck 31, the workpiece 30, the cutting tool 20, a tool fixing part 82, and a tool base 83 are conductors, and the cutting edge of the cutting tool 20 cuts the workpiece 30 at a cutting point 50. Note that, in another example, the cutting apparatus 1d may be a milling machine that rotates the cutting tool 20 attached to the spindle 10 to cause the cutting edge of the cutting tool 20 being rotating to cut into the workpiece 30, or may be another type of machine tool. The cutting apparatus 1d according to the fourth embodiment includes a component identical or similar in structure and function to a corresponding component of the cutting apparatus 1a according to the first embodiment, the component being denoted by the same reference numeral as the corresponding component of the cutting apparatus 1a.

The cutting apparatus 1d according to the fourth embodiment may be an ultra-precision machine tool that achieves machining accuracy on the order of nanometers, and thus the spindle housing 12 has hydrostatic bearings 80a, 80b (hereinafter, referred to as a “hydrostatic bearing 80” unless otherwise specified) that support the spindle 10 via a shaft. The hydrostatic bearing 80 has a function of forcibly sending a lubricating fluid from the outside to between the spindle 10 and a bearing surface to support a load using a hydrostatic pressure generated in a fluid film, and bearing friction is very small. The lubricating fluid may be a gas such as air or may be a liquid such as oil. Note that, in a spindle device 3 shown in FIG. 22, a flow path through which the lubricating fluid is supplied to the spindle 10, a pump that compresses the lubricating fluid, and the like are not shown.

The cutting apparatus 1d includes, on a bed 2, feed mechanisms 84, 85 that move the cutting tool 20 relative to the workpiece 30. The feed mechanism 84 moves a tool base 83 in the X-axis direction (front-rear direction), and the feed mechanism 85 moves the spindle device 3 in the Y-axis direction (up-down direction) and the Z-axis direction (left-right direction). It is preferable that the feed mechanisms 84, 85 have a hydrostatic guide support structure for highly accurate positioning.

The spindle device 3 includes a spindle housing 12 that accommodates the spindle 10 and supports the spindle 10 in a rotatable manner, and is disposed on the feed mechanism 85. The plurality of hydrostatic bearings 80a, 80b, which are radial bearings/thrust bearings, are provided in the spindle housing 12. The hydrostatic bearing 80a is provided on one end of the spindle 10, the hydrostatic bearing 80b is provided on the other end of the spindle 10, and the spindle 10 is supported by the hydrostatic bearings 80a, 80b in a rotatable manner. In the fourth embodiment, the workpiece 30 that is conductive is held by the chuck 31, but in another example, the cutting tool 20 that is conductive may be held by the chuck 31.

The hydrostatic bearing 80 has a relatively wide bearing surface, and the bearing surface and the spindle surface are arranged with an extremely narrow gap provided between the bearing surface and the spindle surface. For example, the axial length of the bearing surface is at least 100 mm, and a distance between the bearing surface and the spindle surface is set at about 10 μm. Therefore, the bearing surface and the spindle surface serve as a capacitor having a relatively large electric capacitance in a state where the lubricating fluid is present between the bearing surface and the spindle surface.

The rotation mechanism 11 includes a structure that rotates the spindle 10, and includes a motor and a transmission structure that transmits rotational power of the motor to the spindle 10. Note that the rotation mechanism 11 is a built-in motor built into the spindle 10, and may directly drive the spindle 10.

The tool base 83 is disposed on the feed mechanism 84. The tool base 83 supports the tool fixing part 82 holding the cutting tool 20, and the tool fixing part 82 and the tool base 83 constitute a fixing part by which the cutting tool 20 is fixed.

The cutting apparatus 1d includes a voltage application unit 86 that applies an alternating-current voltage between the cutting tool 20 and the workpiece 30. The contact monitor 40 monitors the presence or absence of continuity established when the cutting tool 20 and the workpiece 30 come into contact with each other.

The contact monitor 40 includes a conducting wire 42 electrically connected to the spindle housing 12, a conducting wire 43 electrically connected to the fixing part, an electric resistance 44 provided between the conducting wire 42 and the conducting wire 43, and a measurer 45 that measures a voltage applied to the electric resistance 44. Note that the measurer 45 may have a function of measuring a current flowing through the electric resistance 44. The electric signal (voltage or current) measured by the measurer 45 is supplied to the controller 100.

A controller 100 includes a motion controller 101 that controls motion of the cutting tool 20 and/or the workpiece 30, an acquirer 104 that acquires an electric signal measured by the measurer 45, and a processor 105 that specifies a relative positional relationship between the cutting tool 20 and the workpiece 30 from the electric signal acquired by the acquirer 104. The motion controller 101 has a function of moving the cutting tool 20 relative to the workpiece 30 in a direction in which the cutting tool 20 and the workpiece 30 come into contact with each other while imparting rotary motion to one of the cutting tool 20 or the workpiece 30. The motion controller 101 includes a spindle controller 102 that controls rotary motion of the spindle 10 imparted by the rotation mechanism 11, and a movement controller 103 that controls relative movement (feed motion) between the cutting tool 20 and the workpiece 30 imparted by the feed mechanisms 84, 85.

The voltage application unit 86 applies a high-frequency alternating-current voltage between the cutting tool 20 and the workpiece 30. When the cutting apparatus 1d is in operation, a pump (not shown) having a bearing structure is driven, and the spindle controller 102 rotates the spindle 10 in a state where the lubricating fluid is supplied to the outer peripheral surface of the spindle 10. Since the workpiece 30 and the cutting tool 20 are out of contact with each other at the start of rotation of the spindle 10, no current flows through the electric resistance 44, and the voltage measured by the measurer 45 is zero.

Then, the movement controller 103 controls the feed mechanisms 84, 85 to gradually bring the workpiece 30 and the cutting tool 20 closer to each other. When the workpiece 30 and the cutting tool 20 come into contact with each other, a closed circuit is formed by the conducting wire 42, the spindle housing 12, the capacitor formed by the hydrostatic bearing 80 and the spindle 10, the spindle 10, the chuck 31, the workpiece 30, the cutting tool 20, the tool fixing part 82, the tool base 83, the conducting wire 43, and the electric resistance 44 with respect to the alternating-current voltage applied by the voltage application unit 86, and a current flows. The measurer 45 measures a voltage generated across the electric resistance 44 and supplies the resultant to the acquirer 104. The cutting apparatus 1d according to the fourth embodiment has no contact structure 41 connected to the spindle 10 provided, so that it is possible to impart rotary motion to the spindle 10 with high accuracy.

The present disclosure has been described on the basis of the plurality of embodiments. It is to be understood by those skilled in the art that the embodiments are illustrative and that various modifications are possible for a combination of components or processes, and that such modifications are also within the scope of the present disclosure. In the embodiments, the cutting tool 20 and the workpiece 30 are brought into contact with each other in order to derive the relative positional relationship; however, it is preferable that before the contact operation, air blow be applied to blow off cutting oil or chips generated at the previous contact to prevent continuity from being established by the cutting oil or the chips.

In the embodiments, the contact between the cutting tool 20 and the workpiece 30 is detected on the basis of the presence or absence of continuity or a change in voltage, but may be detected using another sensor. For example, whether the contact is made may be detected using a detection value of an AE sensor, a thermoelectromotive force measured by an electric circuit corresponding to the contact monitor 40 without the voltage application unit 46, a spindle load, a motor current, or the like.

The outline of an aspect of the present disclosure is as follows.

A cutting apparatus according to an aspect of the present disclosure includes a motion controller structured to move a cutting tool relative to a workpiece in a direction in which the cutting tool and the workpiece come into contact with each other while imparting rotary motion or motion along a predetermined locus to one of the cutting tool or the workpiece, an acquirer structured to acquire a signal indicating whether the cutting tool and the workpiece are in contact with each other, and a processor structured to specify a section during which the cutting tool and the workpiece are in contact with each other from the signal acquired by the acquirer and specify a relative positional relationship between the cutting tool and the workpiece from the section thus specified.

According to this aspect, it is possible to specify, with high accuracy, the relative positional relationship between the cutting tool and the workpiece from a section during which the cutting tool and the workpiece are in contact with each other.

The processor may derive a depth of cut by which a tool tip of the cutting tool cuts into the workpiece from the section thus specified, and specify the relative positional relationship between the cutting tool and the workpiece using the depth thus derived. It is possible to specify, with accuracy, the relative positional relationship between the cutting tool and the workpiece by deriving the depth of cut. The processor may calculate a ratio of the section to a motion period and derive the depth of cut using the ratio thus calculated. The processor may specify the relative positional relationship between the cutting tool and the workpiece from a section when the cutting tool and the workpiece first come into contact with each other.

The motion controller may include a spindle controller structured to control rotation of a spindle to which a first member is attached, the first member being one of the cutting tool or the workpiece, and a movement controller structured to control relative movement between the first member and a second member that is the other of the cutting tool or the workpiece. The processor may specify a section during which the first member and the second member are in contact with each other from time-series data of the signal acquired by the acquirer and specify a position at which the second member has reached a rotation locus circle of an outermost peripheral point of the first member from a plurality of the sections thus specified.

According to this aspect, it is possible to specify the time when the second member has reached the rotation locus circle of the outermost peripheral point of the first member and specify the position corresponding to the time thus specified by specifying and analyzing the plurality of sections during which the first member and the second member are in contact with each other from the time-series data of the electric signal indicating whether the first member and the second member are in contact with each other.

The processor may calculate a ratio of each of the sections to a rotation period of the spindle, and specify the position at which the second member has reached the rotation locus circle of the outermost peripheral point of the first member using the ratios calculated for the plurality of sections. It is possible to specify, with accuracy, the position at which the second member has reached the rotation locus circle of the outermost peripheral point of the first member using the ratios calculated for the plurality of sections. The processor may specify the position where the second member reaches the rotation locus circle of the outermost peripheral point of the first member using a regression curve obtained by regression analysis of the ratios calculated for the plurality of sections.

The processor may specify the position where the second member reaches the rotation locus circle of the outermost peripheral point of the first member based on the lengths of the plurality of sections. It is possible to specify, with accuracy, the position at which the second member has reached the rotation locus circle of the outermost peripheral point of the first member using the lengths of the plurality of sections. The processor may specify the position at which the second member has reached the rotation locus circle of the outermost peripheral point of the first member using a regression curve obtained through regression analysis performed on the lengths of the plurality of sections.

The processor may specify the position at which the second member has reached the rotation locus circle of the outermost peripheral point of the first member using a relational expression indicating a relationship between an angle section by which the cutting tool comes into contact with the workpiece and a depth of cut by which the cutting tool cuts into the workpiece. It is possible to specify, with accuracy, the position at which the second member has reached the rotation locus circle of the outermost peripheral point of the first member using the relational expression. The processor may derive not only the relative positional relationship but also an amount of eccentricity of the first member attached to the spindle at the same time.

The cutting apparatus may further include a spindle housing structured to accommodate the spindle, the spindle housing including a hydrostatic bearing structured to support the spindle in a rotatable manner, a voltage application unit structured to apply an alternating-current voltage between the first member and the second member, and a measurer structured to measure an electric signal indicating whether the first member and the second member are in contact with each other and supply the electric signal to the acquirer. When the cutting apparatus includes the spindle housing including the hydrostatic bearing, it is possible to measure the electric signal generated when the cutting tool and the workpiece come into contact with each other without the need to bring the contact structure into contact with the spindle by applying the alternating-current voltage between the cutting tool and the workpiece.

A method for specifying a positional relationship according to another aspect of the present disclosure is a method for specifying a relative positional relationship between a cutting tool and a workpiece, the method including imparting rotary motion or motion along a predetermined locus to one of the cutting tool or the workpiece, moving the cutting tool relative to the workpiece in a direction in which the cutting tool and the workpiece come into contact with each other, acquiring a signal indicating whether the cutting tool and the workpiece are in contact with each other, specifying a section during which the cutting tool and the workpiece are in contact with each other from the signal thus acquired, and specifying a relative positional relationship between the cutting tool and the workpiece from the section thus specified.

According to this aspect, it is possible to specify, with high accuracy, the relative positional relationship between the cutting tool and the workpiece from a section during which the cutting tool and the workpiece are in contact with each other.

A cutting apparatus according to another aspect of the present disclosure includes a motion controller structured to move a cutting tool relative to a workpiece in a direction in which the cutting tool and the workpiece come into contact with each other while imparting motion along a predetermined locus to one of the cutting tool or the workpiece, an acquirer structured to acquire a signal indicating whether the cutting tool and the workpiece are in contact with each other, and a processor structured to specify a timing at which the cutting tool and the workpiece come into contact with each other or a timing at which the cutting tool and the workpiece come out of contact with each other from the signal acquired by the acquirer and specify a relative positional relationship between the cutting tool and the workpiece at the timing thus specified.

According to this aspect, it is possible to specify, with high accuracy, the relative positional relationship between the cutting tool and the workpiece while reducing the possibility of damaging the tool. It is preferable that the motion controller continue to impart the motion along the predetermined locus to one of the cutting tool or the workpiece from when the tool tip of the cutting tool comes into contact with the workpiece until when the tool tip of the cutting tool comes out of contact with the workpiece. It is further preferable that the movement amount by which the cutting tool comes close to the workpiece each time the motion along the predetermined locus is imparted be set less than or equal to a machining allowance (finishing allowance) of the workpiece. This makes it possible to reduce the risk of cutting beyond the machining allowance and leaving a contact mark on the finished surface. In order to reliably eliminate the risk, each time the motion along the predetermined locus is imparted, the cutting tool may be temporarily stopped with the cutting tool separated from the workpiece, and whether contact has been made may be checked.

A method for specifying a positional relationship according to another aspect of the present disclosure is a method for specifying a relative positional relationship between a cutting tool and a workpiece, the method including imparting motion along a predetermined locus to one of the cutting tool or the workpiece, moving the cutting tool relative to the workpiece in a direction in which the cutting tool and the workpiece come into contact with each other, acquiring a signal indicating whether the cutting tool and the workpiece are in contact with each other, specifying a timing at which the cutting tool and the workpiece come into contact with each other or a timing at which the cutting tool and the workpiece come out of contact with each other from the signal thus acquired, and specifying a relative positional relationship between the cutting tool and the workpiece at the timing thus specified.

According to this aspect, it is possible to specify, with high accuracy, the relative positional relationship between the cutting tool and the workpiece while reducing the possibility of damaging the tool.

What is claimed is:

1. A cutting apparatus comprising:
a motion controller structured to move a cutting tool relative to a workpiece in a direction in which the cutting tool and the workpiece come into contact with each other while imparting rotary motion or motion along a predetermined locus to one of the cutting tool or the workpiece;
an acquirer structured to acquire a signal indicating whether the cutting tool and the workpiece are in contact with each other; and
a processor structured to specify a section during which the cutting tool and the workpiece are in contact with each other from the signal acquired by the acquirer and specify a relative positional relationship between the cutting tool and the workpiece from the section specified.

2. The cutting apparatus according to claim 1, wherein
the processor derives a depth of cut by which a tool tip of the cutting tool cuts into the workpiece from the section specified, and specifies the relative positional relationship between the cutting tool and the workpiece using the depth derived.

3. The cutting apparatus according to claim 2, wherein
the processor calculates a ratio of the section to a motion period and derives the depth of cut using the ratio calculated.

4. The cutting apparatus according to claim 1, wherein
the processor specifies the relative positional relationship between the cutting tool and the workpiece from a section when the cutting tool and the workpiece first come into contact with each other.

5. The cutting apparatus according to claim 1, wherein
the motion controller includes:
a spindle controller structured to control rotation of a spindle to which a first member is attached, the first member being one of the cutting tool or the workpiece; and
a movement controller structured to control relative movement between the first member and a second member that is the other of the cutting tool or the workpiece.

6. The cutting apparatus according to claim 5, wherein
the processor specifies a section during which the first member and the second member are in contact with each other from time-series data of the signal acquired by the acquirer and specifies a position at which the second member has reached a rotation locus circle of an outermost peripheral point of the first member from a plurality of the sections specified.

7. The cutting apparatus according to claim 6, wherein
the processor calculates a ratio of each of the sections to a rotation period of the spindle, and specifies the position at which the second member has reached the rotation locus circle of the outermost peripheral point of the first member using the ratios calculated for the plurality of sections.

8. The cutting apparatus according to claim 7, wherein
the processor specifies the position at which the second member has reached the rotation locus circle of the outermost peripheral point of the first member using a regression curve obtained through regression analysis performed on the ratios calculated for the plurality of sections.

9. The cutting apparatus according to claim 6, wherein
the processor specifies the position at which the second member has reached the rotation locus circle of the outermost peripheral point of the first member on the basis of lengths of the plurality of sections.

10. The cutting apparatus according to claim 9, wherein
the processor specifies the position at which the second member has reached the rotation locus circle of the outermost peripheral point of the first member using a regression curve obtained through regression analysis performed on the lengths of the plurality of sections.

11. The cutting apparatus according to claim 6, wherein
the processor specifies the position at which the second member has reached the rotation locus circle of the outermost peripheral point of the first member using a relational expression indicating a relationship between an angle section by which the cutting tool comes into contact with the workpiece and a depth of cut by which the cutting tool cuts into the workpiece.

12. The cutting apparatus according to claim 6, wherein
the processor derives an amount of eccentricity of the first member attached to the spindle.

13. The cutting apparatus according to claim 5, further comprising:
a spindle housing structured to accommodate the spindle, the spindle housing including a hydrostatic bearing structured to support the spindle in a rotatable manner;
a voltage application unit structured to apply an alternating-current voltage between the first member and the second member; and
a measurer structured to measure an electric signal indicating whether the first member and the second member are in contact with each other and supply the electric signal to the acquirer.
